(19) United States
(12) Patent Application Publication
(10) Pub. No.: US 2024/0384089 A1
(43) Pub. Date: Nov. 21, 2024

(54) CONTACT LENS AND SILICONE HYDROGEL CONTACT LENS

(71) Applicant: VIZIONFOCUS INC., Miaoli County (TW)

(72) Inventors: WEI-HANG HSU, Miaoli County (TW); CHU-YI YU, Miaoli County (TW); YAO-TSUNG CHENG, Miaoli County (TW)

(21) Appl. No.: 18/663,056

(22) Filed: May 13, 2024

(30) Foreign Application Priority Data
May 16, 2023 (TW) 112118123

(51) Int. Cl. C08L 43/04; C08F 220/28; C08F 226/10; G02B 1/04

(52) U.S. Cl. CPC C08L 43/04; C08F 220/281; C08F 226/10; G02B 1/043; C08L 2203/02

(57) ABSTRACT

A contact lens including at least one silicone monomer is provided, wherein the surface of the contact lens includes polyacrylic acid and/or sodium polyacrylate, and the molecular weight of the polyacrylic acid and/or the sodium polyacrylate is greater than 100 kDa. The present invention further provides a silicone hydrogel contact lens. The contact lens and the silicone hydrogel contact lens provided by the present invention have the advantages of good hydrophilicity and being suitable for consumers' long-time wearing.

### CROSS-REFERENCE TO RELATED APPLICATION

This application claims the priority benefit of Taiwan Application No. 112118123, filed on May 16, 2023. The entirety of the above-mentioned patent application is hereby incorporated by reference herein and made a part of this specification.

### FIELD OF THE INVENTION

The present invention relates to a contact lens and a silicone hydrogel contact lens, in particular to a surface-treated contact lens and a silicone hydrogel contact lens.

### BACKGROUND OF THE INVENTION

Soft contact lens materials have been introduced since the 1960s. Because the soft materials solve the discomfort that is commonly found in Rigid Gas-Permeable lens (RGP Lens) wear, users who have not been used to RGP lenses can switch to using soft contact lenses. Soft contact lenses therefore have become the primary choice for contact lens users today.

However, the materials traditionally used in soft contact lenses (HEMA as the main component, commonly known as hydrogel materials) have a low oxygen permeability and generally a Dk (oxygen permeability) of only 8-20, which often causes consumers (or known as users, or contact lens users) to have bloodshot eyes and corresponding discomfort problems caused by hypoxia at the end of the day of wearing (wearing for more than 10 hours). Therefore, the main direction of research and development of contact lens materials has turned to seek materials having higher oxygen permeability. Since 2000 or so, there was began to appear soft contact lens products containing a silicone component on the market, i.e., contact lens products made of a silicone hydrogel material, which are generally known as silicone hydrogel contact lenses. Compared with conventional hydrogel materials, silicone hydrogel materials have higher oxygen permeability and can solve problems like corneal hypoxia.

The key technical threshold for silicone hydrogel contact lenses is how to confer sufficient hydrophilicity to lenses, thereby avoiding wear discomfort caused by hydrophobicity of silicone components. The surface hydrophilicity of lens is typically judged by using contact angle in the industry. It was first developed in the industry to perform surface treatment on lenses by plasma technology, for example, patent literatures US 20030039748 and U.S. Pat. No. 5,760,100. However, this technology requires complicated processes in which the cost of lens production is high. Furthermore, there is another method that polyvinylpyrrolidone (PVP) is added into the formulation as an internal wetting agent, such as in patent literatures U.S. Pat. Nos. 6,367,929, 6,943,203, 7,052,131, 7,249,848, 7,473,738, and 7,691,916. This method avoids complicated processes of plasma surface treatment; however, there are many constraints to lens formulations. In addition to the above two technologies, some researchers have also developed formulation technologies that neither plasma surface treatment nor the additional addition of PVP as an internal wetting agent is required, such as described in patent literatures U.S. Pat. Nos. 7,750,079, 8,129,442, 8,231,218, 8,476,337, and EP 195584 A2. However, formulation technologies of this class require the combination of specific silicone monomers, specific hydrophilic monomers and specific diluents to achieve the desired lens properties, and usually require using specific mold materials for the production of contact lenses. These limitations constrain the optimization of production cost.

Therefore, it is necessary to design a set of contact lenses that can meet consumers' needs, are suitable for long-time wearing, are convenient for mass production, and have high quality and competitive cost.

### SUMMARY OF THE INVENTION

The present invention provides a contact lens that is suitable for consumers' long-time wearing and is convenient for mass production.

The present invention further provides a silicone hydrogel contact lens that is suitable for consumers' long-time wearing and is convenient for mass production.

For achieving the aforementioned advantages, one embodiment of the present invention provides a contact lens, including at least one silicone monomer, and a surface of the contact lens includes polyacrylic acid and/or sodium polyacrylate; wherein a molecular weight of the polyacrylic acid and/or the sodium polyacrylate is preferably greater than 100 kDa, more preferably greater than 200 kDa and more preferably greater than 450 kDa.

For achieving the aforementioned advantages, another embodiment of the present invention provides a silicone hydrogel contact lens, including a first silicone monomer, a second silicone monomer, a first hydrophilic monomer, a second hydrophilic monomer and a silicone crosslinking agent. A surface of the silicone hydrogel contact lens includes polyacrylic acid and/or sodium polyacrylate; wherein a molecular weight of the polyacrylic acid and/or the sodium polyacrylate is preferably greater than 100 kDa, more preferably greater than 200 kDa and more preferably greater than 450 kDa.

The aforementioned first silicone monomer includes the following structure:

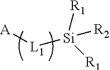

wherein A is the following structure:

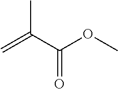

or the following structure:

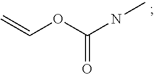

wherein R₁ is H or CH₃ or OSi(CH₃)₃; R₂ is H or CH₃ or OSi(CH₃)₃; and L₁ is the following structure or a combination thereof:

(CH₂)ₙ₁, (Cₘ₁H₂ₘ₁Oₘ₂)ₘ₃ or

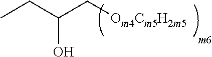

wherein n1 is 1-5, m1 is 1-4, m2 is 0-1, m3 is 1-4, m4 is 0-1, m5 is 1-4, and m6 is 1-4.

The aforementioned second silicone monomer includes a first structure or a second structure;

the aforementioned first structure is:

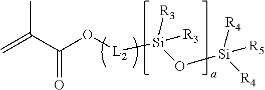

wherein a is 0-20; R₃ is H or CH₃ or C₂H₅; R₄ is H or CH₃ or OSi(CH₃)₃; R₅ is H or CH₃ or OSi(CH₃)₃; and L₂ is the following structure or a combination thereof:

(CH₂)ₙ₆, (Cₘ₇H₂ₘ₇Oₘ₈)ₘ₉,

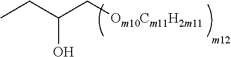

or

(CH₂)ₙ₇NHCO(Oₘ₁₃Cₘ₁₄H₂ₘ₁₄)ₘ₁₅

wherein n6 is 1-5, n7 is 1-5, m7 is 1-4, m8 is 0-1, m9 is 1-4, m10 is 0-1, m11 is 1-4, m12 is 1-4, m13 is 0-1, m14 is 1-4, and m15 is 1-4;

the aforementioned second structure is:

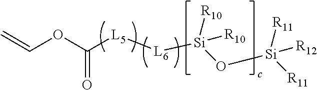

wherein c is 0-20; R₁₀ is H or CH₃ or C₂H₅; R₁₁ is H or CH₃ or OSi(CH₃)₃; R₁₂ is H or CH₃ or OSi(CH₃)₃; and L₅ is the following structure or a combination thereof: O or NH;

L₆ is the following structure or a combination thereof:

(CH₂)ₙ₂₀, (Cₘ₃₄H₂ₘ₃₄Oₘ₃₅)ₘ₃₆ or

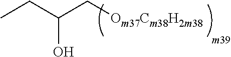

wherein n20 is 1-5, m34 is 1-4, m35 is 0-1, m36 is 1-4, m37 is 0-1, m38 is 1-4, and m39 is 1-4.

The aforementioned first hydrophilic monomer is an N-vinyl-containing hydrophilic monomer, and the aforementioned second hydrophilic monomer is different from the first hydrophilic monomer.

The aforementioned first silicone monomer includes at least one of 3-[tris(trimethylsiloxy)silyl]propyl methacrylate, 3-(3-methacryloxy-2-hydroxypropoxy)propylbis(trimethylsiloxy)-methylsilane, O-(methacryloxyethyl)-3-[bis(trimethylsiloxy)methylsilyl]propylcarbamate, and 3-[tris(trimethylsiloxy)silyl]propyl vinyl carbamate.

The aforementioned second silicone monomer includes at least one of monomethacryloxypropyl terminated polydimethylsiloxane, monomethacryloxypropyl terminated carbamate polydimethylsiloxane, and mono-(3-methacryloxy-2-hydroxypropyloxy)propyl terminated, mono-butyl terminated polydimethylsiloxane. A molecular weight of the second silicone monomer is 350-2500 Da, more preferably 500-1500 Da.

The aforementioned silicone hydrogel contact lens further includes a diluent, and the total content of the first silicone monomer and the second silicone monomer accounts for 15%-60% by weight, more preferably 25%-45% by weight, of the silicone hydrogel contact lens from which the diluent is deducted.

The aforementioned first hydrophilic monomer is N-vinyl pyrrolidone or N-methyl-N-vinylacetamide.

The aforementioned silicone hydrogel contact lens further includes a diluent, and the content of the first hydrophilic monomer accounts for 30%-65% by weight, more preferably 35%-55% by weight, of the silicone hydrogel contact lens from which the diluent is deducted.

The aforementioned second hydrophilic monomer includes hydroxyethyl methacrylate.

The aforementioned silicone crosslinking agent includes the following structure:

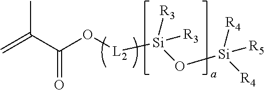

wherein b is 0-20; R₆ is H or CH₃ or C₂H₅, R₇ is H or CH₃ or OSi(CH₃)₃; and L₃ is the following structure or a combination thereof:

(CH₂)ₙ₁₂, (Cₘ₁₆H₂ₘ₁₆Oₘ₁₇)ₘ₁₈,

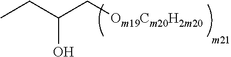

or (CH₂)ₙ₁₃NHCO(Oₘ₂₂Cₘ₂₃H₂ₘ₂₃)ₘ₂₄

wherein n12 is 1-5, n13 is 1-5, m16 is 1-4, m17 is 0-1, m18 is 1-4, m19 is 0-1, m20 is 1-4, m21 is 1-4, m22 is 0-1, m23 is 1-4, and m24 is 1-4;

R₈ is the following structure:

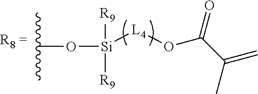

wherein R₉ is H or CH₃ or C₂H₅; and L₄ is the following structure or a combination thereof:

(CH₂)ₙ₁₈, (Cₘ₂₅H₂ₘ₂₅Oₘ₂₆)ₘ₂₇,

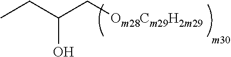

or (CH₂)ₙ₁₉NHCO(Oₘ₃₁Cₘ₃₂H₂ₘ₃₂)ₘ₃₃

wherein n18 is 1-5, n19 is 1-5, m25 is 1-4, m26 is 0-1, m27 is 1-4, m28 is 0-1, m29 is 1-4, m30 is 1-4, m31 is 0-1, m32 is 1-4, and m33 is 1-4.

The aforementioned silicone crosslinking agent includes the following structure:

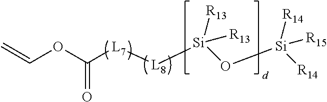

wherein d is 0-20; R₁₃ is H or CH₃ or C₂H₅; R₁₄ is H or CH₃ or C₂H₅; and L₇ is the following structure or a combination thereof: O or NH;

L₈ is the following structure or a combination thereof:

(CH₂)ₙ₂₅, (Cₘ₄₀H₂ₘ₄₀Oₘ₄₁)ₘ₄₂ or

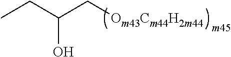

wherein n25 is 1-5, m40 is 1-4, m41 is 0-1, m42 is 1-4, m43 is 0-1, m44 is 1-4, and m45 is 1-4;

R₁₅ is the following structure:

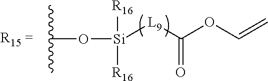

wherein R₁₆ is H or CH₃ or C₂H₅; and L₉ is the following structure or a combination thereof:

(CH₂)ₙ₃₁, (Cₘ₄₆H₂ₘ₄₆Oₘ₄₇)ₘ₄₈ or

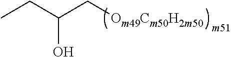

wherein n31 is 1-5, m46 is 1-4, m47 is 0-1, m48 is 1-4, m49 is 0-1, m50 is 1-4, and m51 is 1-4.

The aforementioned silicone crosslinking agent includes at least one of methacryloxypropyl terminated polydimethylsiloxane, methacryloxypropyl terminated carbamate polydimethylsiloxane, polyethylene glycol functionalized methacryloxypropyl terminated polydimethylsiloxane, 1,3-bis[4-(vinyloxycarbonyloxy)butyl]-tetramethyldisiloxane, and bis-3-methacryloxy-2-hydroxypropyloxypropyl polydimethylsiloxane; wherein a molecular weight of the silicone crosslinking agent is between 500 Da and 3000 Da.

The aforementioned silicone hydrogel contact lens further includes at least one non-silicone crosslinking agent, wherein the at least one non-silicone crosslinking agent includes at least one of ethylene glycol dimethacrylate, triethylene glycol dimethacrylate, tetraethylene glycol dimethacrylate, and trimethylolpropane trimethacrylate.

The aforementioned contact lens is a silicone hydrogel contact lens having a contact angle of less than or equal to 60°, a water break-up time (WBUT) of greater than or equal to 20 seconds, and a tear break-up time of greater than about 15 seconds even after wearing for about 8 to 10 hours.

The contact lens and the silicone hydrogel contact lens according to the embodiments of the present invention include at least one silicone monomer, and the surfaces of the contact lens and the silicone hydrogel contact lens include polyacrylic acid and/or sodium polyacrylate, wherein a molecular weight of polyacrylic acid and/or sodium polyacrylate is greater than 100 kDa. Hence, the contact lens and the silicone hydrogel contact lens produced have the advantages of better hydrophilicity and being suitable for consumers' long-time wearing.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic cross-sectional view of a contact lens according to an embodiment of the present invention; and

FIG. 2 is a schematic flow chart illustrating a method of manufacturing a contact lens according to an embodiment of the present invention.

### DETAILED DESCRIPTION OF PREFERRED EMBODIMENTS

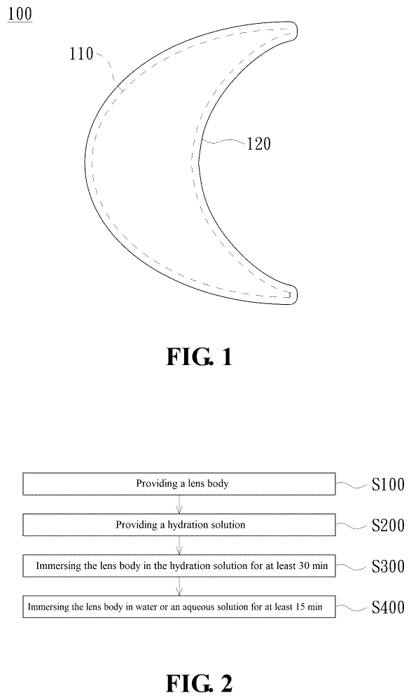

An embodiment of the present invention provides a contact lens 100. The contact lens 100 includes a lens body 110. The lens body 110 includes at least one silicone monomer, and a surface of the contact lens 100 includes polyacrylic acid and/or sodium polyacrylate 120. FIG. 1 is a schematic cross-sectional view of a contact lens according to an embodiment of the present invention. Referring to FIG. 1, specifically the polyacrylic acid and/or sodium polyacrylate 120 is a film covering the lens body 110, which is the surface of the contact lens 100. The surface of the contact lens 100 described above may include convex surfaces, concave surfaces, or a combination thereof. Since the polyacrylic acid and sodium polyacrylate 120 are hydrophilic, they can improve the hydrophilicity of the contact lens 100 when used as the surface of the contact lens 100. In addition, the surface of the contact lens 100 does not include, for example, any polymer other than the polyacrylic acid or sodium polyacrylate 120 that has opposite charges to polyacrylic acid or sodium polyacrylate. In other words, the contact lens 100 of this embodiment, for example, has the lens body 110 only covered with the film formed of polyacrylic acid and/or sodium polyacrylate 120. A molecular weight of the polyacrylic acid and/or sodium polyacrylate 120 is preferably greater than about 100 kDa, more preferably greater than about 200 kDa, and more preferably greater than about 450 kDa. Specifically, the contact lens 100 described above is, for example, a silicone hydrogel contact lens, wherein the lens body 110 of the contact lens 100 may include a first silicone monomer, a second silicone monomer, a first hydrophilic monomer, a second hydrophilic monomer and a silicone crosslinking agent.

The first silicone monomer includes the following structure:

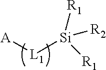

wherein A is the following structure:

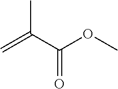

or the following structure:

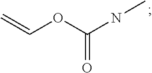

wherein R₁ is H or CH₃ or OSi(CH₃)₃; R₂ is H or CH₃ or OSi(CH₃)₃; and L₁ is the following structure or a combination thereof:

(CH₂)ₙ₁, (Cₘ₁H₂ₘ₁Oₘ₂)ₘ₃ or

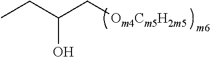

wherein n1 is 1-5, m1 is 1-4, m2 is 0-1, m3 is 1-4, m4 is 0-1, m5 is 1-4, and m6 is 1-4.

The second silicone monomer includes a first structure or a second structure as follows:

the first structure is:

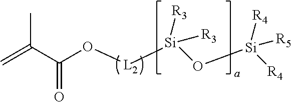

wherein a is 0-20; R₃ is H or CH₃ or C₂H₅; R₄ is H or CH₃ or OSi(CH₃)₃; R₅ is H or CH₃ or OSi(CH₃)₃; and L₂ is the following structure or a combination thereof:

(CH₂)ₙ₆, (Cₘ₇H₂ₘ₇Oₘ₈)ₘ₉,

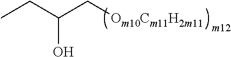

or

(CH₂)ₙ₇NHCO(Oₘ₁₃Cₘ₁₄H₂ₘ₁₄)ₘ₁₅

wherein n6 is 1-5, n7 is 1-5, m7 is 1-4, m8 is 0-1, m9 is 1-4, m10 is 0-1, m11 is 1-4, m12 is 1-4, m13 is 0-1, m14 is 1-4, and m15 is 1-4;

the second structure is:

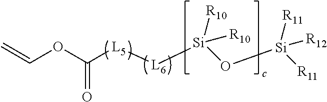

wherein c is 0-20; R₁₀ is H or CH₃ or C₂H₅; R₁₁ is H or CH₃ or OSi(CH₃)₃; R₁₂ is H or CH₃ or OSi(CH₃)₃; and L₅ is the following structure or a combination thereof: O or NH;

L₆ is the following structure or a combination thereof:

(CH₂)ₙ₂₀, (Cₘ₃₄H₂ₘ₃₄Oₘ₃₅)ₘ₃₆ or

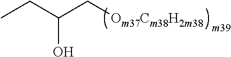

wherein n20 is 1-5, m34 is 1-4, m35 is 0-1, m36 is 1-4, m37 is 0-1, m38 is 1-4, and m39 is 1-4.

The aforementioned first hydrophilic monomer includes N-vinyl. The aforementioned second hydrophilic monomer is different from the first hydrophilic monomer; wherein the second hydrophilic monomer including 2-hydroxyethyl methacrylate (HEMA) is particularly effective.

A contact angle of the aforementioned contact lens is less than or equal to 60°, a water break-up time (WBUT) of the aforementioned contact lens is greater than or equal to 20 seconds, and a tear break-up time of the aforementioned contact lens is greater than about 15 seconds even after wearing for about 8 to 10 hours.

Herein, contact lens may refer to contact lenses that have been hydrated, or contact lenses that have been hydrated and sterilized. Herein, lens may be interchanged with contact lens in some contexts, while in some contexts, lens may refer to lens body or dry lens that has not been hydrated. In addition, lens formulations (referred to as the formulations) herein refer to formulations consisting essentially of monomer(s), crosslinking agent(s) and an initiator. The formulation may further include a diluent if necessary. “Monomer” is used to refer to those in a lens formulation that can be polymerized through free radical polymerization in a curing process to further form a polymer. Monomers typically have a double bond that can receive free radicals in the chemical structure.

“Silicone monomer” refers to those belonging to the monomer category and having a chemical structure of at least one silicon-oxygen bond (—Si—O—). The silicone monomers that can be used in this embodiment are for example: 3-[tris(trimethylsiloxy)silyl]propyl methacrylate (TRIS), and monomethacryloxypropyl terminated polydimethylsiloxane (MPDMS). The common monomethacryloxypropyl terminated polydimethylsiloxane is CAS No. 146632-07-7. Other silicone monomers that may be used in this embodiment include, but not limited to: 2-(trimethylsilyloxy)ethyl methacrylate, 3-(3-methacryloxy-2-hydroxypropoxy)propylbis-(trimethylsiloxy)methylsilane (SiGMA), (methacryloxymethyl)bis-(trimethylsiloxy)methylsilane, methacryloxymethylphenethyltris(trimethylsiloxy)silane, O-(methacryloxyethyl)-3-[bis(trimethylsiloxy)methylsilyl]propylcarbamate, and 3-[tris(trimethylsiloxy)silyl]propyl vinyl carbamate. The above-mentioned silicone monomers are commercially available from suppliers such as Sigma-Aldrich, Gelest, JNC, Shin-Etsu, Pharnocia, and Bimax. Silicone monomers that can be used in this embodiment also include, for example, mono-(3-methacryloxy-2-hydroxypropyloxy)propyl terminated, mono-butyl terminated polydimethylsiloxane, which can be obtained by referring to the synthesis method in the United States patent US20030162862A1. The silicone monomers that can be used in this embodiment also include, for example, urethane ester of monocarbinol terminated polydimethylsiloxane (CAS No: 207308-30-3, MOHPMDS) and 2-isocyanatoethyl methacrylate (IEM). The synthesis reaction of the urethane ester may use 1,8-diazabicyclo[5.4.0]undec-7-ene (DBU) as a catalyst.

The first silicone monomer may include the following structure:

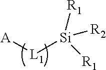

wherein A is the following structure:

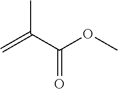

or the following structure:

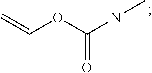

wherein R₁ is H or CH₃ or OSi(CH₃)₃; R₂ is H or CH₃ or OSi(CH₃)₃; and L₁ is the following structure or a combination thereof:

(CH₂)ₙ₁, (Cₘ₁H₂ₘ₁Oₘ₂)ₘ₃ or

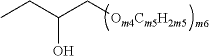

wherein n1 is 1-5, m1 is 1-4, m2 is 0-1, m3 is 1-4, m4 is 0-1, m5 is 1-4, and m6 is 1-4.

In this embodiment, the above-mentioned first silicone monomer includes, for example, at least one of 3-[tris(trimethylsiloxy)silyl]propyl methacrylate, 3-(3-methacryloxy-2-hydroxypropoxy)propylbis(trimethylsiloxy)-methylsilane, O-(methacryloxyethyl)-3-[bis(trimethylsiloxy)methylsilyl]propylcarbamate, and 3-[tris(trimethylsiloxy)silyl]propyl vinyl carbamate.

The above-mentioned second silicone monomer includes, for example, at least one of monomethacryloxypropyl terminated polydimethylsiloxane, monomethacryloxypropyl terminated carbamate polydimethylsiloxane, and mono-(3-methacryloxy-2-hydroxypropyloxy)propyl terminated, mono-butyl terminated polydimethylsiloxane. In addition, a molecular weight of the above-mentioned second silicone monomer may be 350-2500, and more preferably 500-1500.

The second silicone monomer includes a first structure or a second structure;

the first structure is:

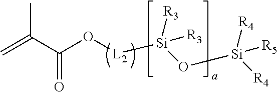

wherein a is 0-20; R₃ is H or CH₃ or C₂H₅; R₄ is H or CH₃ or OSi(CH₃)₃; R₅ is H or CH₃ or OSi(CH₃)₃; and L₂ is the following structure or a combination thereof:

(CH₂)ₙ₆, (Cₘ₇H₂ₘ₇Oₘ₈)ₘ₉,

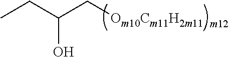

or

(CH₂)ₙ₇NHCO(Oₘ₁₃Cₘ₁₄H₂ₘ₁₄)ₘ₁₅

wherein n6 is 1-5, n7 is 1-5, m7 is 1-4, m8 is 0-1, m9 is 1-4, m10 is 0-1, m11 is 1-4, m12 is 1-4, m13 is 0-1, m14 is 1-4, and m15 is 1-4;

the second structure is:

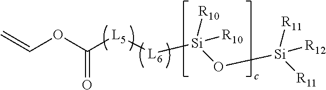

wherein c is 0-20; R₁₀ is H or CH₃ or C₂H₅; Rᵤ is H or CH₃ or structure or a combination thereof: O or NH;

L₆ is the following structure or a combination thereof:

(CH₂)ₙ₂₀, (Cₘ₃₄H₂ₘ₃₄Oₘ₃₅)ₘ₃₆ or

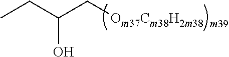

wherein n20 is 1-5, m34 is 1-4, m35 is 0-1, m36 is 1-4, m37 is 0-1, m38 is 1-4, and m39 is 1-4.

The first hydrophilic monomer is an N-vinyl-containing hydrophilic monomer, e.g., N-vinyl pyrrolidone and N-methyl-N-vinylacetamide.

The total content of the first silicone monomer and the second silicone monomer accounts for 15%-60% by weight, more preferably 25%-45% by weight, of the contact lens from which the diluent is deducted.

“Hydrophilic monomer” refers to those belonging to the monomer category and having a relatively hydrophilic chemical structure. Hydrophilic monomers that can be used in this embodiment include, but not limited to: N-vinyl pyrrolidone (NVP), N-methyl-N-vinylacetamide (MVA), N,N-dimethyl acrylamide (DMA), N,N-diethylacrylamide, N-(hydroxymethyl)acrylamide, N-hydroxyethyl acrylamide, 2-hydroxyethyl methacrylate (HEMA), ethylene glycol vinyl ether (EGVE), 1,4-butanediol vinyl ether (BVE), di(ethylene glycol) vinyl ether, hydroxypropyl methacrylate and/or hydroxyisopropyl methacrylate, hydroxybutyl methacrylate (HOBMA), poly(propylene ethylene glycol) methacrylate, poly(ethpropylene glycol) acrylate, glyceryl methacrylate, glycidyl methacrylate, 2-hydroxyethyl acrylate, hydroxypropyl acrylate and/or hydroxyisopropyl acrylate, 4-hydroxybutyl acrylate, glyceryl acrylate, N-[tris(hydroxymethyl)methyl]acrylamide, methacrylamide, 2-hydroxypropyl methacrylamide, N-isopropylacrylamide, N,N-diethylacrylamide, N-ethylacrylamide, 2-ethoxyethyl methacrylate (EOEMA), polyethylene glycol dimethacrylate (PEGDMA), and 2-methacryloyloxyethyl phosphorylcholine and the like. In this embodiment, the preferred choice of the hydrophilic monomer is N-vinyl pyrrolidone or N-methyl-N-vinylacetamide (MVA). More preferred choice is a combination of N-vinyl pyrrolidone (NVP) and 2-hydroxyethyl methacrylate (HEMA), or a combination of N-methyl-N-vinyl acetamide (MVA) and 2-hydroxyethyl methacrylate (HEMA). The above-mentioned hydrophilic monomers may be commercially available from suppliers such as Sigma-Aldrich, TCI, and Alfa Aesar. In addition to “hydrophilic monomer”, “hydrophobic monomer” can also be optionally added to the formulation to adjust the mechanical properties of lenses. For instance, in some embodiments of the present invention, methyl methacrylate (MMA) is added.

In one embodiment of the present invention, the aforementioned first hydrophilic monomer is, for example, N-vinyl pyrrolidone or N-methyl-N-vinylacetamide (MVA). Additionally, the content of the aforementioned first hydrophilic monomer accounts for 30%-65% by weight of the contact lens from which the diluent is deducted.

In one embodiment of the present invention, the aforementioned first hydrophilic monomer is, for example, N-vinyl pyrrolidone or N-methyl-N-vinylacetamide (MVA). Additionally, the content of the aforementioned first hydrophilic monomer accounts for 35%-55% by weight of the contact lens from which the diluent is deducted.

In one embodiment of the present invention, the above-mentioned second hydrophilic monomer includes, for example, at least one of 2-hydroxyethyl methacrylate (HEMA), ethylene glycol vinyl ether, and 1,4-butanediol vinyl ether, wherein 2-hydroxyethyl methacrylate (HEMA) has the optimal effect. Currently there is no specific explanation on a theoretical framework, and the inventors do not want to limit the invention to certain theoretical frameworks. However, the present invention has unexpectedly discovered that silicone polymer structure formed by 2-hydroxyethyl methacrylate (HEMA) having a hydroxyl group in structure in conjunction with a first hydrophilic monomer containing N-vinyl may form a proper hydrogen bond or van der Waals force with polyacrylic acid and/or sodium polyacrylate, thereby helping polyacrylic acid and/or sodium polyacrylate to be more stably adsorbed on the lens surface, or form an entanglement with the polymer structure of the lens surface after being adsorbed on the lens surface, thus allowing polyacrylic acid and/or sodium polyacrylate to more stably stay on the lens surface and allowing contact lenses better quality and more suitable for wearing.

“UV blocker” refers to a component added to lenses to allow lenses to block UV wavelength light. UV blockers commonly used in contact lenses also have a double bond that can receive free radicals in the chemical structure, and hence also belong to the category of monomers. UV blockers that may be used in this embodiment include, but not limited to: 2-[3-(2H-benzotriazol-2-yl)-4-hydroxyphenyl]ethyl methacrylate (HMEPB), and 2-(4-benzoyl-3-hydroxyphenoxy)ethyl acrylate. The above-mentioned UV blockers may be commercially available from suppliers such as Sigma-Aldrich, TCI, and Alfa Aesar.

In this embodiment, the aforementioned contact lens may further include at least one non-silicone crosslinking agent.

“Crosslinking agent” refers to a component that enables monomers to perform a crosslinking reaction during a polymerization reaction, and renders the polymer produced by the polymerization reaction the required crosslinking density, so as to allow the two polymer chains to react and bond into a network of polymers. Specifically, crosslinking agents may be divided into non-silicone crosslinking agents and silicone crosslinking agents according to whether they have a chemical structure of a silicon-oxygen bond (—Si—O—). Non-silicone crosslinking agents that may be used in this embodiment include, but not limited to: ethylene glycol dimethacrylate (EGDMA), di(ethylene glycol) dimethacrylate, triethylene glycol dimethacrylate, tetraethylene glycol dimethacrylate (TEGDMA), ethylene glycol diacrylate, di(ethylene glycol) diacrylate, triethylene glycol diacrylate, tetraethylene glycol diacrylate, N,N′-methylenebis(acrylamide), N,N′-ethylenebis(acrylamide), N,N′-(1,2-dihydroxyethylene)bisacrylamide, trimethylolpropane trimethacrylate (TEPTMA), N,N′-hexamethylenebis(methacrylamide), glycerol trimethacrylate, polyethylene glycol dimethacrylate, polyethylene glycol diacrylate, mono-2-(methacryloyloxy)ethyl maleate, diurethane dimethacrylate, 3-isopropenyl-α,α-dimethylbenzylisocyanate, diethylene glycol monovinyl ether (DEGVE), and tri(ethylene glycol) divinyl ether (TEGDVE) and the like. The above-mentioned non-silicone crosslinking agents may be commercially available from suppliers such as Sigma-Aldrich, TCI, and Alfa Aesar.

In this embodiment, the aforementioned at least one non-silicone crosslinking agent includes, for example, at least one of ethylene glycol dimethacrylate, triethylene glycol dimethacrylate, tetraethylene glycol dimethacrylate, and trimethylolpropane trimethacrylate.

“Silicone crosslinking agent” refers to those belonging to the category of crosslinking agent and having a chemical structure of at least one silicon-oxygen bond (—Si—O—). Silicone crosslinking agents that may be used in this embodiment include, but not limited to, the following examples. For example, methacryloxypropyl terminated polydimethylsiloxane (DMPDMS) may be used. The CAS No. of commonly used methacrylopropyl terminated polydimethylsiloxane is 58130-03-3. Another example is polyethylene glycol functionalized methacryloxypropyl terminated polydimethylsiloxane as shown in the following structure:

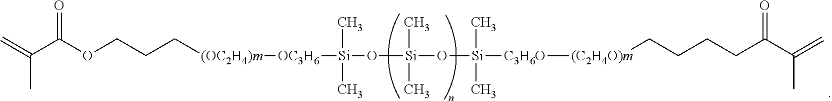

A silicone crosslinking agent may be used in combination with other crosslinking agents to achieve proper properties of lenses. In this embodiment, the above-mentioned silicone crosslinking agents are commercially available from suppliers such as Sigma-Aldrich, Gelest, JNC, Shin-Etsu, Pharnocia, and Bimax and the like. The silicone crosslinking agents that may be used in this embodiment further include, for example, 1,3-bis[4-(vinyloxycarbonyloxy)butyl]tetramethyldisiloxane, which can be obtained by referring to the synthesis method in the U.S. Pat. No. 5,070,215 A. The silicone crosslinking agents that may be used in this embodiment further include, for example, bis-3-methacryloxy-2-hydroxypropyloxypropyl polydimethylsiloxane, referring to the synthesis method in the United States patent application publication US 20030162862 A1, which is obtained by replacing mono-(2,3-epoxy)propylether terminated polydimethylsiloxane with epoxypropoxypropyl terminated polydimethylsiloxane. The silicone crosslinking agents that may be used in this embodiment further include, for example, urethane ester of carbinol(hydroxyl) terminated polydimethylsiloxane (DOHPDMS, CAS No: 156327-07-0) and 2-isocyanatoethyl methacrylate (IEM). The synthesis reaction of the urethane ester may use 1,8-diazabicyclo[5.4.0]undec-7-ene (DBU) as a catalyst.

In one embodiment of the present invention, the aforementioned silicone crosslinking agent, for example, includes the following structure:

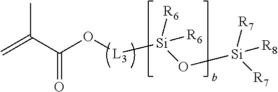

wherein b is 0-20; R₆ is H or CH₃ or C₂H₅; R₇ is H or CH₃ or OSi(CH₃)₃; and L₃ is the following structure or a combination thereof:

(CH₂)ₙ₁₂, (Cₘ₁₆H₂ₘ₁₆Oₘ₁₇)ₘ₁₈,

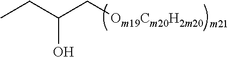

or

(CH₂)ₙ₁₃NHCO(Oₘ₂₂Cₘ₂₃H₂ₘ₂₃)ₘ₂₄

wherein n12 is 1-5, n13 is 1-5, m16 is 1-4, m17 is 0-1, m18 is 1-4, m19 is 0-1, m20 is 1-4, m21 is 1-4, m22 is 0-1, m23 is 1-4, and m24 is 1-4;

R₈ is the following structure:

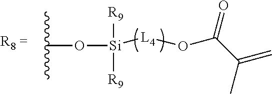

wherein R₉ is H or CH₃ or C₂H₅; and L₄ is the following structure or a combination thereof:

(CH₂)ₙ₁₈, (Cₘ₂₅H₂ₘ₂₅Oₘ₂₆)ₘ₂₇,

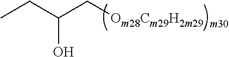

or (CH₂)ₙ₁₉NHCO(Oₘ₃₁Cₘ₃₂H₂ₘ₃₂)ₘ₃₃

wherein n18 is 1-5, n19 is 1-5, m25 is 1-4, m26 is 0-1, m27 is 1-4, m28 is 0-1, m29 is 1-4, m30 is 1-4, m31 is 0-1, m32 is 1-4, and m33 is 1-4.

In one embodiment of the present invention, the aforementioned silicone crosslinking agent, for example, includes the following structure:

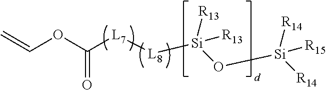

wherein d is 0-20; R₁₃ is H or CH₃ or C₂H₅; R₁₄ is H or CH₃ or C₂H₅; and L₇ is the following structure or a combination thereof: O or NH;

L₈ is the following structure or a combination thereof:

(CH₂)ₙ₂₅, (Cₘ₄₀H₂ₘ₄₀Oₘ₄₁)ₘ₄₂ or

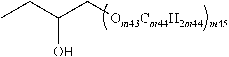

wherein n25 is 1-5, m40 is 1-4, m41 is 0-1, m42 is 1-4, m43 is 0-1, m44 is 1-4, and m45 is 1-4;

R₁₅ is the following structure:

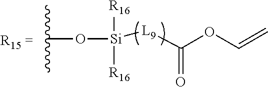

wherein R₁₆ is H or CH₃ or C₂H₅; and L₉ is the following structure or a combination thereof:

(CH₂)ₙ₃₁, (Cₘ₄₆H₂ₘ₄₆Oₘ₄₇)ₘ₄₈ or

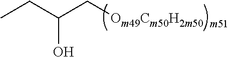

wherein n31 is 1-5, m46 is 1-4, m47 is 0-1, m48 is 1-4, m49 is 0-1, m50 is 1-4, and m51 is 1-4.

In one embodiment of the present invention, the aforementioned silicone crosslinking agent includes, for example, at least one of methacryloxypropyl terminated polydimethylsiloxane, methacryloxypropyl terminated carbamate polydimethylsiloxane, polyethylene glycol functionalized methacryloxypropyl terminated polydimethylsiloxane, 1,3-bis[4-(vinyloxycarbonyloxy)butyl]tetramethyldisiloxane, and bis-3-methacryloxy-2-hydroxypropyloxypropyl polydimethylsiloxane.

In one embodiment of the present application, it is observed that the lens having a formulation composition including a silicone crosslinking agent has a lower degree of haze after being treated with a hydration solution including polyacrylic acid and/or sodium polyacrylate. This may be because the lens body including a silicone crosslinking agent has a higher degree of polymerization with silicone monomers (e.g., a first silicone monomer and a second silicone monomer), but has a lower degree of polymerization with non-silicone monomers, so that the overall lens structure formed will not allow polyacrylic acid and/or sodium polyacrylate to penetrate too deeply into the inner structure of the lens, but only stay on the lens surface, thereby reducing haze in the lens. Therefore, a molecular weight of polyacrylic acid and/or sodium polyacrylate, a concentration of polyacrylic acid and/or sodium polyacrylate in a hydration solution, as well as an appropriate silicone crosslinking agent and an appropriate molecular weight thereof in combination may effectively obtain contact lenses that meet the following conditions: a contact angle of less than or equal to 60°, a water break-up time (WBUT) of greater than or equal to 20 seconds, and a tear break-up time of greater than 15 seconds even after wearing for about 8 to 10 hours, while contact lenses have an acceptable haze degree.

The above-mentioned silicone crosslinking agent has a molecular weight of preferably between 500 and 5000, more preferably between 700 and 3000, and even more preferably between 900 and 2000.

The total content of the above-mentioned silicone crosslinking agent accounts for, for example, 0.1%-6.0% by weight, preferably 0.1%-3.0% by weight, of the contact lens from which the diluent is deducted.

“Initiator” plays a role of generating free radicals required for the free radical polymerization. Generally, according to different ways in which they are initiated to generate free radicals, initiators may be divided into thermal initiators which could be initiated by heat to generate free radicals, and photoinitiators which could be initiated by light to generate free radicals. Photoinitiators that may be used in this embodiment include, but not limited to: Irgacure® 1173 (2-hydroxy-2-methylpropiophenone), and phenylbis(2,4,6-trimethylbenzoyl)phosphine oxide (for short 819). In other embodiments, for example, diphenyl(2,4,6-trimethylbenzoyl)phosphine oxide and 2,2-dimethoxy-2-phenylacetophenone are used. Thermal initiators that may be used in this embodiment include, but not limited to: azobisisobutyronitrile, 4,4′-azobis(4-cyanovaleric acid), 1,1′-azobis(cyclohexanecarbonitrile), 2,2′-azobis(2-methylpropionamidine)dihydrochloride, 2,2′-azobis[2-(2-imidazolin-2-yl)propane]dihydrochloride, 2,2′-azobis{2-[1-(2-hydroxyethyl)-2-imidazolin-2-yl]propane}-dihydrochloride, 2,2′-azobis(1-imino-1-pyrrolidino-2-ethylpropane)dihydrochloride, 2,2′-azobis{2-methyl-N-[1,1-bis(hydroxymethyl)-2-hydroxyethyl]-propionamide}, 2,2′-azobis[2-methyl-N-(2-hydroxyethyl)propionamide], 2,2′-azobis(4-methoxy-2,4-dimethyl valeronitrile), and benzoyl peroxide and the like. The above-mentioned initiators may be commercially available from suppliers such as Sigma-Aldrich, TCI, and Alfa Aesar, etc.

“Diluent” refers to a component additionally added to a lens formulation, which is a chemical substance that does not have a double bond that can receive free radicals to cause the free radical polymerization, and thus cannot polymerize with monomers or a crosslinking agent or an initiator to further form a polymer. Some diluents may also function as chain transfer agents and be involved in part of the free radical polymerization process, but their chain transfer effects are generally much inferior to real chain transfer agents such as thiols. Thus, in this embodiment, the function of diluent as a chain transfer agent is not considered. Diluents are typically used to facilitate the compatibility of ingredients in lens formulation. Solvent-based compounds may all be choices of diluents. Diluents that may be used in this embodiment include, but not limited to: alcohols, such as ethanol, isopropyl alcohol (IPA), n-butanol, n-hexanol (hexanol), and tert-amyl alcohol; esters, such as ethyl acetate, butyl acetate and ethyl lacetate; organic acids, such as oleic acid; and alcohol ethers, such as ethyl cellosolve, 2-propoxyethanol, ethylene glycol monobutyl ether, hexyl cellosolve, ethylene glycol monophenyl ether, propylene glycol monomethyl ether, propylene glycol phenyl ether, 2-(2-methoxyethoxy)ethanol, 2-(2-ethoxyethoxy)ethanol, diethylene glycol monobutyl ether, diethylene glycol hexyl ether, dipropylene glycol monomethyl ether, dipropylene glycol propyl ether and dipropylene glycol n-butyl ether. The above-mentioned diluents may be commercially available from suppliers such as Sigma-Aldrich, TCI, and Alfa Aesar.

Surface hydrophilicity of a contact lens may be determined in the following ways. First, surface hydrophilicity of a contact lens may be determined by measuring contact angle. Contact angle can be measured by the Sessile Drop method or the Captive Bubble method. The contact angles in the embodiments illustrated in the present invention are measured by the Sessile Drop method.

Another method for determining the hydrophilicity of a contact lens includes taking out the contact lens from water, or an aqueous solution containing buffer salts, or an aqueous solution containing a surfactant (e.g., Poloxamer 407 or Tween-80), or an aqueous solution containing both buffer salts and a surfactant (such as Poloxamer 407 or Tween-80), removing excess moisture from the lens surface by gently shaking the contact lens, and observing and recording how long it takes that the water layer breaks up on the lens surface. The time from the start of test to a break-up of the water layer on the lens surface is called Water Break-up Time (WBUT).

Another measurement method closer to the needs of contact lens users is to provide sterilized contact lenses to a subject for wearing, and observe the eyes of the subject wearing the contact lenses by a professional qualified optometrist with a slit lamp for the time taken for a break-up of the tear layer after a blink. The time from the start of observation after a blink to a break-up of the tear layer on the surface of lens on the eye is called Tear Break-up Time (TBUT). In general, the lower the contact angle of a contact lens, correspondingly the longer the water break-up time, while correspondingly the longer the tear break-up time, and the better the surface hydrophilicity of the contact lens.

The present invention also provides a preparation method of a contact lens, including making a lens body (i.e., a dry lens) and treating the lens body with a hydration solution followed by washing with water, or an aqueous solution including a buffer solution, or an aqueous solution including a small amount of a surfactant, wherein the hydration solution is an organic solution including polyacrylic acid and/or sodium polyacrylate, so that the contact lens with the lens body covered with polyacrylic acid and/or sodium polyacrylate is obtained. Contact lenses can be sterilized in an autoclave, and sterilized contact lenses are available for wearing. A lens body is composed of silicone units, non-silicone units, a crosslinking agent and an initiator, and may further include a diluent if necessary. The preparation of a lens body includes providing a composition including silicone units, non-silicone units, a crosslinking agent, and an initiator, and further a diluent if necessary, mixing and stirring uniformly to form a formulation, injecting the formulation into a mold that controls the shape and size of the lens to form a formulation-mold complex, and then polymerizing, crosslinking and curing polymerizable units in the formulation via photocuring or thermocuring to form the lens body.

FIG. 2 is a schematic flow chart illustrating a method of manufacturing a contact lens according to an embodiment of the present invention. Referring to FIG. 2, in one embodiment of the present invention, a method of manufacturing a contact lens includes step S100: providing a lens body; step S200: providing a hydration solution, which is an organic solution including polyacrylic acid and/or sodium polyacrylate, wherein polyacrylic acid and/or sodium polyacrylate account for 0.01-10 wt % of the hydration solution; step S300: immersing the lens body in the hydration solution for at least 30 minutes; and step S400: immersing the lens body in water or an aqueous solution for at least 15 minutes, wherein the aqueous solution includes buffer salts and/or a surfactant. It should be noted that this embodiment does not specifically restrict the order in which step S100 and step S200 are performed. In another embodiment, step S100 and step S200 may also be performed simultaneously.

That is, the method of manufacturing a contact lens includes two parts: the first part uses a hydration solution including polyacrylic acid and/or sodium polyacrylate, an organic solvent and water that have been uniformly mixed to immerse the lens body, i.e., step S200 and step S300. The immersion temperature may be room temperature, wherein the room temperature is, for example, 20-30° C. By allowing polyacrylic acid and/or sodium polyacrylate to have a sufficient adsorption force (such as hydrogen bonding and van der Waals force) with the lens of the specified formulation, and by further selecting polyacrylic acid and/or sodium polyacrylate having a sufficiently large molecular weight, the embodiments of the present invention enable polyacrylic acid and/or sodium polyacrylate to form a stable entanglement with the crosslinked polymer structure on the lens surface, and a sufficient and constant amount of polyacrylic acid and/or sodium polyacrylate thus can be maintained on the lens surface without being washed away in the subsequent manufacturing process. Therefore, there is no need for a chemical reaction of polyacrylic acid and/or sodium polyacrylate with the lens body to form a covalent bond, and thus heating is not necessarily required in step S300. In case of requiring temperature control for other manufacturing purposes, the temperature of the hydration solution may be controlled at 10-80° C. An aqueous solution including polyacrylic acid and/or sodium polyacrylate used as a hydration solution can effectively reduce the surface hydrophobicity (lowering the contact angle, increasing the water break-up time (WBUT), and increasing the tear break-up time when wearing contact lenses) of conventional silicone lens bodies. Furthermore, hydration in the first part can help the lens body change from a dry lens to a wet lens while reducing the problem of the surface hydrophobicity of a lens. The immersion time ranges, for example, from half an hour to 12 hours, and all have corresponding effects of reducing the surface hydrophobicity of the lens to different degrees, which can significantly optimize the feeling of lens wearing and solve the problem of the surface hydrophobicity of lenses.

Polymers may be selected from: poly(acrylic acid) or poly(acrylic acid sodium salt) with different molecular weights, used alone or selected from combinations thereof. Generally speaking, a certain range of molecular weight can have excellent performance. The molecular weight is preferably in a range of about 100 kDa or more, more preferably in a range of about 200 kDa or more, and more preferably in a range of about 450 kDa or more. In terms of the proportion of polymers in the hydration solution, the proportion is preferably in a range of 0.01-10 wt %, more preferably in a range of about 0.05-5 wt %, and more preferably in a range of about 0.1-1.5 wt %. The proportion of polymers in the hydration solution may be determined depending on the requirements for lens surface quality (such as contact angle, water break-up time (WBUT), and tear break-up time when wearing contact lenses on the eyes), the molecular weight of polymer and the units that compose the lens body.

In most embodiments of the present invention, staining the contact lenses with Toluidine Blue O before or after sterilization demonstrates that the contact lenses and the method of manufacturing a contact lens according to the embodiments of the present invention allow polymers, e.g., polyacrylic acid and/or sodium polyacrylate, to retain on the surface of the contact lenses, thereby improving the surface hydrophilicity of the lenses.

In most embodiments of the present invention, when the molecular weight of polyacrylic acid and/or sodium polyacrylate used in the hydration solution is above 200 kDa, inclusive, it can ensure that at the beginning of wearing (within 10 min from wearing contact lenses) and after wearing for more than 8-10 hours, subjects have a TBUT of above 15 seconds. In some embodiments, when the molecular weight of polyacrylic acid and/or sodium polyacrylate used in the hydration solution is below 25 kDa, inclusive, even if the measured contact angles of the contact lenses are less than 50 degrees, it is still observed that some subjects have a TBUT of less than 15 seconds. In some embodiments, when the molecular weight of polyacrylic acid and/or sodium polyacrylate is about 100 kDa, even if the measured contact angles of the contact lenses are less than 20-30 degrees, and subjects have a TBUT of greater than 15 seconds at the beginning of wearing, however, some subjects would have a TBUT less than 15 seconds after wearing for more than 8 to 10 hours.

The organic solvent accounts for 1-90 wt %, preferably 20-60 wt %, of the hydration solution. Common organic solvents include, but not limited to: tripropylene glycol methyl ether, dipropylene glycol methyl ether, ethylene glycol n-butyl ether, ketones, e.g., acetone, methyl ethyl ketone, etc., diethylene glycol n-butyl ether, diethylene glycol methyl ether, ethylene glycol phenyl ether, propylene glycol methylether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether, dipropylene glycol dimethyl ether, polyethylene glycols, polypropylene glycols, ethyl acetate, butyl acetate, amyl acetate, methyl lactate, ethyl lactate, i-propyl lactate, monohydroxy alcohols (e.g., 1-butanol, 2-butanol, 1-propanol, 2-propanol, methanol, ethanol, cyclohexanol, cyclopentanol, exo-norborneol, 1-pentanol, 2-pentanol, 3-pentanol, 1-hexanol, 2-hexanol, 3-hexanol, 3-methyl-2-butanol, 1-heptanol, 2-heptanol, 1-octanol, 2-octanol, 1-nonanol, 2-nonanol, 1-decanol, 2-decanol, 3-octanol, norborneol, tert-butanol, tert-amyl alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl 2-propanol, 5-methyl-2-heptanol, 2-methyl-2-octanol, 2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol, 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-propanol, t-amyl alcohol, and isopropanol), 1-methyl-2-pyrrolidone, N,N-dimethylpropionamide, dimethyl formamide, dimethyl acetamide, dimethyl propionamide, N-methylpyrrolidinone, 1,2-propylene glycol, polyethylene glycol having a molecular weight of equal to or less than 200 Da, tetrahydrofuran, methylene chloride, and mixtures thereof.

The second part of the method of manufacturing a contact lens is subsequently performed after the first part, i.e., step S400: using water (RO water or pure water), or an aqueous solution including buffer salts, or an aqueous solution including a small amount of a surfactant (such as Poloxamer 407 or Tween-80), or an aqueous solution including both buffer salts and a small amount of a surfactant. That is, after it is immersed in the hydration solution for a certain period of time, the lens body is immersed in water or an aqueous solution to wash away the residual organic solvent on the surface and in the inner layer of the contact lens. The time for the lens body to immerse in water or the aqueous solution is preferably at least 15 to 30 minutes, thereby ensuring the cleaning and replacement. The immersion may be carried out at a constant temperature, or by alternating hot and cold (or at variable temperatures). For example, a fixed temperature of water or an aqueous solution is chosen in a range from room temperature to 60° C. to immerse a lens; or a lens is immersed in water or an aqueous solution at a cold temperature and a warm temperature alternately, and the temperature range will not have any improper influence on the materials of the lenses. The thermal expansion and contraction of the lens body caused by temperature changes can promote the leaching-out of the organic solvent. The choices of temperature and whether the immersion is carried out at a constant temperature or variable temperatures can be determined based on the types of the organic solvent.

Preferably, water or an aqueous solution including buffer salts in the second part (i.e., step S400) may further include a trace amount of a surfactant, wherein the amount of the surfactant used is adjusted in proportion to the number of lens bodies to be treated. For example, if 5-100 mL of water is used per lens, 500 mL to 10 L of water will be used when 100 lens bodies are washed at one time. The more water is used, the less the number of washing is needed; otherwise, the more the number of washing is needed. During or after step S400, the residual organic solvent on the lens body can be checked by any conventional method. The immersion of step S400 may be performed multiple times, for example, immersion again after changing water, and preferably immersion twice in total including at least one water change. The number of immersion may be adjusted according to the types of the organic solvent and the residual organic solvent. For example, the amount of the organic solvent measured in water or the aqueous solution after immersion is preferably less than 1 ppm. If it is much more than 1 ppm, water or the aqueous solution may be changed for further immersion.

The step of immersing a lens body in water or an aqueous solution in the second part of the method of manufacturing a contact lens can further change the expansion rate of the wet lens in the first part, that is, after the treatment of the second part, the diameter of the lens body changes again and reaches the preset diameter of the contact lens. The conditions and results of the method of manufacturing a lens body are further illustrated through Embodiments 1-81. Compounds used in the following embodiments include

| Chemical Name | Abbreviation |
|---|---|
| (3-[tris(trimethylsiloxy)silyl]propyl methacrylate | TRIS |
| 3-(3-methacryloxy-2-hydroxypropoxy)propylbis- | SiGMA |
| (trimethylsiloxy)methylsilane | |
| 3-[tris(trimethylsiloxy)silyl]propyl vinyl carbamate | |
| monomethacryloxypropyl terminated polydimethylsiloxane | MPDMS |
| (methacryloxymethyl)bis(trimethylsiloxy)methylsilane | |
| methacryloxymethylphenethyltris(trimethylsiloxy)silane | |
| 0-(methacryloxyethyl)-3-[bis(trimethylsiloxy)methylsilyl]- | |
| propylcarbamate | |
| 2-hydroxyethyl methacrylate | HEMA |
| 2-ethoxyethyl methacrylate | EOEMA |
| methyl methacrylate | MMA |
| isobornyl methacrylate | IBM |
| N-vinyl pyrrolidone | NVP |
| N,N-dimethyl acrylamide | DMA |
| 1,4-butanediol vinyl ether | BVE |
| diethylene glycol monovinyl ether | DEGVE |
| methacryloxypropyl terminated polydimethylsiloxane | DMPDMS |
| polyethylene glycol functionalized methacryloxypropyl | |
| terminated polydimethylsiloxane | |
| ethylene glycol dimethacrylate | EGDMA |
| tetraethylene glycol dimethacrylate | TEGDMA |
| polyethylene glycol dimethacrylate | PEGDMA |
| tri(ethylene glycol) divinyl ether | TEGDVE |
| phenylbis(2,4,6-trimethylbenzoyl)phosphine oxide | 819 |
| 2-hydroxy-2-methylpropiophenone | 1173 |
| 2-[3-(2H-benzotriazol-2-yl)-4-hydroxyphenyl]ethyl | HMEPB |
| methacrylate | |
| 2-allyloxyethanol | |
| isopropyl alcohol | IPA |
| n-hexanol | Hexanol |
| ethyl acetate | |
| propyl acetate | |
| butyl acetate | |
| ethyl lactate | |
| tert-amyl alcohol | tAA |
| tripropylene glycol methyl ether | TPME |

The compounds used in the embodiments are illustrated in commonly used abbreviations.

### Embodiment 1

Step S100: providing a lens body. The lens body of this embodiment is the first of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 12.70% SIGMA, 15.61% MPDMS (having a molecular weight of about 1000), 1.57% MMA, 65.67% NVP, 1.35% DMPDMS, 1.95% TEGDMA, 0.58% 819, and 0.57% HMEPB. The total amount above was 100%, including monomers, an initiator, and a crosslinking agent. Taking the above total amount as the denominator in weight percentage, 9.53% hexanol and 9.53% ethyl acetate were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 2 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 81.24°.

### Embodiment 2

Step S100: providing a lens body. The lens body of this embodiment is the second of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 15.17% TRIS, 18.25% (methacryloxymethyl)bis(trimethylsiloxy)methylsilane, 3.37% IBM, 61.65% NVP, 0.34% TEGDMA, 0.61% 819, and 0.61% HMEPB. The total amount above was 100%, including monomers, an initiator, and a crosslinking agent. Taking the above total amount as the denominator in weight percentage, 10.17% hexanol and 9.53% ethyl acetate were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 2 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 83.07°.

### Embodiment 3

Step S100: providing a lens body. The lens body of this embodiment is the third of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 16.11% SIGMA, 18.23% (methacryloxymethyl)bis(trimethylsiloxy)methylsilane, 2.00% HEMA, 54.15% NVP, 5.33% IBM, 2.50% DMPDMS, 1.00% TEGDMA, and 0.68% 819. The total amount above was 100%, including monomers, an initiator, and a crosslinking agent. Taking the above total amount as the denominator in weight percentage, 11.33% hexanol and 11.33% propyl acetate were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 2 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 68.91°.

### Embodiment 4

Step S100: providing a lens body. The lens body of this embodiment is the fourth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 24.59% methacryloxymethylphenethyltris(trimethylsiloxy)silane, 15.39% O-(methacryloxyethyl)-3-[bis(trimethylsiloxy)methylsilyl]-propylcarbamate, 4.00% HEMA, 53.55% NVP, 0.89% EGDMA, 0.60% 819, and 0.98% HMEPB. The total amount above was 100%, including monomers, an initiator, and a crosslinking agent. Taking the above total amount as the denominator in weight percentage, 10.00% ethyl acetate and 10.00% TPME were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 2 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 69.03°.

### Embodiment 5

Step S100: providing a lens body. The lens body of this embodiment is the fifth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 23.25% 3-[tris(trimethylsiloxy)silyl]propyl vinyl carbamate, 27.15% (methacryloxymethyl)bis(trimethylsiloxy)methylsilane, 8.00% HEMA, 1.00% EOEMA, 35.98% NVP, 1.5% polyethylene glycol functionalized methacryloxypropyl terminated polydimethylsiloxane, 1.50% PEGDMA, 0.62% 819, and 1.00% HMEPB. The total amount above was 100%, including monomers, an initiator, and a crosslinking agent. Taking the above total amount as the denominator in weight percentage, 10.00% ethyl acetate and 10.00% ethyl lactate were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 2 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution 1 for 1 hour, and then in the second tank of hydration solution 1 for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 70.14°.

### Embodiment 6

Step S100: providing a lens body. The lens body of this embodiment is the sixth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 14.40% TRIS, 16.32% MPDMS, 12.00% HEMA, 54.24% NVP, 0.58% polyethylene glycol functionalized methacryloxypropyl terminated polydimethylsiloxane, 1.26% TEGDMA, 0.60% 819, and 0.60% HMEPB. The total amount above was 100%, including monomers, an initiator, and a crosslinking agent. Taking the above total amount as the denominator in weight percentage, 10.00% hexanol and 10.00% propyl acetate were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 2 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 73.89°.

### Embodiment 7

Step S100: providing a lens body. The lens body of this embodiment is the seventh of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 17.26% 3-[tris(trimethylsiloxy)silyl]propyl vinyl carbamate, 16.15% MPDMS, 16.00% HEMA, 49.95% NVP, 0.40% TEGDMA, and 0.24% 819. The total amount above was 100%, including monomers, an initiator, and a crosslinking agent. Taking the above total amount as the denominator in weight percentage, 12.10% hexanol and 12.10% tAA were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 2 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 79.61°.

### Embodiment 8

Step S100: providing a lens body. The lens body of this embodiment is the eighth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 17.25% SIGMA, 13.52% methacryloxymethylphenethyltris(trimethylsiloxy)silane, 20.00% HEMA, 47.18% NVP, 1.36% EGDMA, and 0.69% 819. The total amount above was 100%, including monomers, an initiator, and a crosslinking agent. Taking the above total amount as the denominator in weight percentage, 11.44% IPA and 11.44% hexanol were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 2 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 80.72°.

### Embodiment 9

Step S100: providing a lens body. The lens body of this embodiment is the ninth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 5.70% SIGMA, 11.11% 3-[tris(trimethylsiloxy)silyl]propyl vinyl carbamate, 12.00% MPDMS, 34.58% NVP, 33.40% DMA, 1.38% DEGVE, 1.15% TEGDMA, and 0.68% 819. The total amount above was 100%, including monomers, an initiator, and a crosslinking agent. Taking the above total amount as the denominator in weight percentage, 11.33% butyl acetate and 11.33% hexanol were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 2 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 85.96°.

### Embodiment 10

Step S100: providing a lens body. The lens body of this embodiment is the tenth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 13.15% TRIS, 10.25% (methacryloxymethyl)bis(trimethylsiloxy)-methylsilane, 10.25% HEMA, 32.06% NVP, 31.54% DMA, 1.21% BVE, 0.80% EGDMA, 0.10% TEGDVE, and 0.64% 819. The total amount above was 100%, including monomers, an initiator, and a crosslinking agent. Taking the above total amount as the denominator in weight percentage, 10.44% ethyl lactate and 12.44% hexanol were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 2 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 91.86°.

### Embodiment 11

Step S100: providing a lens body. The lens body of this embodiment is the first of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 12.70% SIGMA, 15.61% MPDMS (having a molecular weight of about 1000), 1.57% MMA, 65.67% NVP, 1.35% DMPDMS, 1.95% TEGDMA, 0.58% 819, and 0.57% HMEPB. The total amount above was 100%, including monomers, an initiator, and a crosslinking agent. Taking the above total amount as the denominator in weight percentage, 9.53% hexanol and 9.53% ethyl acetate were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3-5 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 70.94°.

### Embodiment 12

Step S100: providing a lens body. The lens body of this embodiment is the second of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 15.17% TRIS, 18.25% (methacryloxymethyl)bis(trimethylsiloxy)methylsilane, 3.37% IBM, 61.65% NVP, 0.34% TEGDMA, 0.61% 819, and 0.61% HMEPB. The total amount above was 100%, including monomers, an initiator, and a crosslinking agent. Taking the above total amount as the denominator in weight percentage, 10.17% hexanol and 9.53% ethyl acetate were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3-5 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 68.49°.

### Embodiment 13

Step S100: providing a lens body. The lens body of this embodiment is the third of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 16.11% SIGMA, 18.23% (methacryloxymethyl)bis(trimethylsiloxy)-methylsilane, 2.00% HEMA, 54.15% NVP, 5.33% IBM, 2.50% DMPDMS, 1.00% TEGDMA, and 0.68% 819. The total amount above was 100%, including monomers, an initiator, and a crosslinking agent. Taking the above total amount as the denominator in weight percentage, 11.33% hexanol and 11.33% propyl acetate were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3-5 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 40.12°.

### Embodiment 14

Step S100: providing a lens body. The lens body of this embodiment is the fourth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 24.59% methacryloxymethylphenethyltris(trimethylsiloxy)silane, 15.39% O-(methacryloxyethyl)-3-[bis(trimethylsiloxy)methylsilyl]propylcarbamate, 4.00% HEMA, 53.55% NVP, 0.89% EGDMA, 0.60% 819, and 0.98% HMEPB. The total amount above was 100%, including monomers, an initiator, and a crosslinking agent. Taking the above total amount as the denominator in weight percentage, 10.00% ethyl acetate and 10.00% TPME were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3-5 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 37.59°.

### Embodiment 15

Step S100: providing a lens body. The lens body of this embodiment is the fifth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 23.25% 3-[tris(trimethylsiloxy)silyl]propyl vinyl carbamate, 27.15% (methacryloxymethyl)bis(trimethylsiloxy)methylsilane, 8.00% HEMA, 1.00% EOEMA, 35.98% NVP, 1.5% polyethylene glycol functionalized methacryloxypropyl terminated polydimethylsiloxane, 1.50% PEGDMA, 0.62% 819, and 1.00% HMEPB. The total amount above was 100%, including monomers, an initiator, and a crosslinking agent. Taking the above total amount as the denominator in weight percentage, 10.00% ethyl acetate and 10.00% ethyl lactate were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3-5 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 66.52°.

### Embodiment 16

Step S100: providing a lens body. The lens body of this embodiment is the sixth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 14.40% TRIS, 16.32% MPDMS, 12.00% HEMA, 54.24% NVP, 0.58% polyethylene glycol functionalized methacryloxypropyl terminated polydimethylsiloxane, 1.26% TEGDMA, 0.60% 819, and 0.60% HMEPB. The total amount above was 100%, including monomers, an initiator, and a crosslinking agent. Taking the above total amount as the denominator in weight percentage, 10.00% hexanol and 10.00% propyl acetate were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3-5 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 68.07°.

### Embodiment 17

Step S100: providing a lens body. The lens body of this embodiment is the seventh of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 17.26% 3-[tris(trimethylsiloxy)silyl]propyl vinyl carbamate, 16.15% MPDMS, 16.00% HEMA, 49.95% NVP, 0.40% TEGDMA, and 0.24% 819. The total amount above was 100%, including monomers, an initiator, and a crosslinking agent. Taking the above total amount as the denominator in weight percentage, 12.10% hexanol and 12.10% tAA were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3-5 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 74.84°.

### Embodiment 18

Step S100: providing a lens body. The lens body of this embodiment is the eighth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 17.25% SIGMA, 13.52% methacryloxymethylphenethyltris(trimethylsiloxy)silane, 20.00% HEMA, 47.18% NVP, 1.36% EGDMA, and 0.69% 819. The total amount above was 100%, including monomers, an initiator, and a crosslinking agent. Taking the above total amount as the denominator in weight percentage, 11.44% IPA and 11.44% hexanol were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3-5 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 84.21°.

### Embodiment 19

Step S100: providing a lens body. The lens body of this embodiment is the ninth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 5.70% SIGMA, 11.11% 3-[tris(trimethylsiloxy)silyl]propyl vinyl carbamate, 12.00% MPDMS, 34.58% NVP, 33.40% DMA, 1.38% DEGVE, 1.15% TEGDMA, and 0.68% 819. The total amount above was 100%, including monomers, an initiator, and a crosslinking agent. Taking the above total amount as the denominator in weight percentage, 11.33% butyl acetate and 11.33% hexanol were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3-5 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 81.98°.

### Embodiment 20

Step S100: providing a lens body. The lens body of this embodiment is the tenth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 13.15% TRIS, 10.25% (methacryloxymethyl)bis(trimethylsiloxy)-methylsilane, 10.25% HEMA, 32.06% NVP, 31.54% DMA, 1.21% BVE, 0.80% EGDMA, 0.10% TEGDVE, and 0.64% 819. The total amount above was 100%, including monomers, an initiator, and a crosslinking agent. Taking the above total amount as the denominator in weight percentage, 10.44% ethyl lactate and 12.44% hexanol were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3-5 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 87.61°.

### Embodiment 21

Step S100: providing a lens body. The lens body of this embodiment is the first of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 12.70% SIGMA, 15.61% MPDMS (having a molecular weight of about 1000), 1.57% MMA, 65.67% NVP, 1.35% DMPDMS, 1.95% TEGDMA, 0.58% 819, and 0.57% HMEPB. The total amount above was 100%, including monomers, an initiator, and a crosslinking agent. Taking the above total amount as the denominator in weight percentage, 9.53% hexanol and 9.53% ethyl acetate were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 25 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 65.14°.

### Embodiment 22

Step S100: providing a lens body. The lens body of this embodiment is the second of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 15.17% TRIS, 18.25% (methacryloxymethyl)bis(trimethylsiloxy)methylsilane, 3.37% IBM, 61.65% NVP, 0.34% TEGDMA, 0.61% 819, and 0.61% HMEPB. The total amount above was 100%, including monomers, an initiator, and a crosslinking agent. Taking the above total amount as the denominator in weight percentage, 10.17% hexanol and 9.53% ethyl acetate were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 25 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 54.09°.

### Embodiment 23

Step S100: providing a lens body. The lens body of this embodiment is the third of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 16.11% SIGMA, 18.23% (methacryloxymethyl)bis(trimethylsiloxy)-methylsilane, 2.00% HEMA, 54.15% NVP, 5.33% IBM, 2.50% DMPDMS, 1.00% TEGDMA, and 0.68% 819. The total amount above was 100%, including monomers, an initiator, and a crosslinking agent. Taking the above total amount as the denominator in weight percentage, 11.33% hexanol and 11.33% propyl acetate were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 25 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 50.18°.

### Embodiment 24

Step S100: providing a lens body. The lens body of this embodiment is the fourth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 24.59% methacryloxymethylphenethyltris(trimethylsiloxy)silane, 15.39% O-(methacryloxyethyl)-3-[bis(trimethylsiloxy)methylsilyl]propylcarbamate, 4.00% HEMA, 53.55% NVP, 0.89% EGDMA, 0.60% 819, and 0.98% HMEPB. The total amount above was 100%, including monomers, an initiator, and a crosslinking agent. Taking the above total amount as the denominator in weight percentage, 10.00% ethyl acetate and 10.00% TPME were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 25 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 44.98°.

### Embodiment 25

Step S100: providing a lens body. The lens body of this embodiment is the fifth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 23.25% 3-[tris(trimethylsiloxy)silyl]propyl vinyl carbamate, 27.15% (methacryloxymethyl)bis(trimethylsiloxy)methylsilane, 8.00% HEMA, 1.00% EOEMA, 35.98% NVP, 1.5% polyethylene glycol functionalized methacryloxypropyl terminated polydimethylsiloxane, 1.50% PEGDMA, 0.62% 819, and 1.00% HMEPB. The total amount above was 100%, including monomers, an initiator, and a crosslinking agent. Taking the above total amount as the denominator in weight percentage, 10.00% ethyl acetate and 10.00% ethyl lactate were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 25 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 40.17°.

### Embodiment 26

Step S100: providing a lens body. The lens body of this embodiment is the sixth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 14.40% TRIS, 16.32% MPDMS, 12.00% HEMA, 54.24% NVP, 0.58% polyethylene glycol functionalized methacryloxypropyl terminated polydimethylsiloxane, 1.26% TEGDMA, 0.60% 819, and 0.60% HMEPB. The total amount above was 100%, including monomers, an initiator, and a crosslinking agent. Taking the above total amount as the denominator in weight percentage, 10.00% hexanol and 10.00% propyl acetate were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 25 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 46.49°.

### Embodiment 27

Step S100: providing a lens body. The lens body of this embodiment is the seventh of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 17.26% 3-[tris(trimethylsiloxy)silyl]propyl vinyl carbamate, 16.15% MPDMS, 16.00% HEMA, 49.95% NVP, 0.40% TEGDMA, and 0.24% 819. The total amount above was 100%, including monomers, an initiator, and a crosslinking agent. Taking the above total amount as the denominator in weight percentage, 12.10% hexanol and 12.10% tAA were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 25 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 69.66°.

### Embodiment 28

Step S100: providing a lens body. The lens body of this embodiment is the eighth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 17.25% SIGMA, 13.52% methacryloxymethylphenethyltris(trimethylsiloxy)silane, 20.00% HEMA, 47.18% NVP, 1.36% EGDMA, and 0.69% 819. The total amount above was 100%, including monomers, an initiator, and a crosslinking agent. Taking the above total amount as the denominator in weight percentage, 11.44% IPA and 11.44% hexanol were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 25 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 81.07°.

### Embodiment 29

Step S100: providing a lens body. The lens body of this embodiment is the ninth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 5.70% SIGMA, 11.11% 3-[tris(trimethylsiloxy)silyl]propyl vinyl carbamate, 12.00% MPDMS, 34.58% NVP, 33.40% DMA, 1.38% DEGVE, 1.15% TEGDMA, and 0.68% 819. The total amount above was 100%, including monomers, an initiator, and a crosslinking agent. Taking the above total amount as the denominator in weight percentage, 11.33% butyl acetate and 11.33% hexanol were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 25 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 80.93°.

### Embodiment 30

Step S100: providing a lens body. The lens body of this embodiment is the tenth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 13.15% TRIS, 10.25% (methacryloxymethyl)bis(trimethylsiloxy)-methylsilane, 10.25% HEMA, 32.06% NVP, 31.54% DMA, 1.21% BVE, 0.80% EGDMA, 0.10% TEGDVE, and 0.64% 819. The total amount above was 100%, including monomers, an initiator, and a crosslinking agent. Taking the above total amount as the denominator in weight percentage, 10.44% ethyl lactate and 12.44% hexanol were additionally added to the lens formulation. The mixed formulation was stirred under nitrogen for more than 4 hours to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 minutes. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 25 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 minutes. In this embodiment, the lens body was allowed to stand and immerse in the first tank of hydration solution for 1 hour, and then in the second tank of hydration solution for 1 hour, that is, the first part of the treatment was 2 hours in total. The lens body can also be immersed in the same tank for sufficient time without moving to other tanks. The immersion temperature was room temperature.

Step S400: immersing the lens body in water or an aqueous solution for at least 60 minutes to form a contact lens. In this embodiment, four tanks were provided, and the lens body was immersed sequentially in the four tanks each for 1 hour, a total of 4 hours. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 minutes to form a contact lens. The lens body may be immersed sequentially in four tanks, each tank for 15 minutes, a total of 60 minutes.

It was observed or measured and calculated that the five experimental contact lenses prepared in this embodiment had an average contact angle of 92.02°.

### Embodiment 31

Step S100: providing a lens body. The lens body of this embodiment is the first of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 12.70% SIGMA, 15.61% MPDMS (having a molecular weight of about 1000), 1.57% MMA, 65.67% NVP, 1.35% DMPDMS, 1.95% TEGDMA, 0.58% 819, and 0.57% HMEPB. The total amount above was 100%, including monomers, an initiator, and a crosslinking agent. Taking the above total amount as the denominator in weight percentage, 9.53% hexanol and 9.53% ethyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 100 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 50.21°.

### Embodiment 32

Step S100: providing a lens body. The lens body of this embodiment is the second of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 15.17% TRIS, 18.25% (methacryloxymethyl)bis(trimethylsiloxy)methylsilane, 3.37% IBM, 61.65% NVP, 0.34% TEGDMA, 0.61% 819, and 0.61% HMEPB. The total amount above was 100%, including monomers, an initiator, and a crosslinking agent. Taking the above total amount as the denominator in weight percentage, 10.17% hexanol and 9.53% ethyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 100 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 49.89°.

### Embodiment 33

Step S100: providing a lens body. The lens body of this embodiment is the third of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 16.11% SIGMA, 18.23% (methacryloxymethyl)bis(trimethylsiloxy)-methylsilane, 2.00% HEMA, 54.15% NVP, 5.33% IBM, 2.50% DMPDMS, 1.00% TEGDMA, and 0.68% 819. The total amount above was 100%, including monomers, an initiator, and a crosslinking agent. Taking the above total amount as the denominator in weight percentage, 11.33% hexanol and 11.33% propyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 0.5 wt % PAA having a molecular weight of 100 kDa and 99.5 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 20.02°.

### Embodiment 34

Step S100: providing a lens body. The lens body of this embodiment is the fourth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 24.59% methacryloxymethylphenethyltris(trimethylsiloxy)silane, 15.39% O-(methacryloxyethyl)-3-[bis(trimethylsiloxy)methylsilyl]-propylcarbamate, 4.00% HEMA, 53.55% NVP, 0.89% EGDMA, 0.60% 819, and 0.98% HMEPB. The total amount above was 100%, including monomers, an initiator, and a crosslinking agent. Taking the above total amount as the denominator in weight percentage, 10.00% ethyl acetate and 10.00% TPME were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 100 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 18.12°.

### Embodiment 35

Step S100: providing a lens body. The lens body of this embodiment is the fifth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 23.25% 3-[tris(trimethylsiloxy)silyl]propyl vinyl carbamate, 27.15% (methacryloxymethyl)bis(trimethylsiloxy)methylsilane, 8.00% HEMA, 1.00% EOEMA, 35.98% NVP, 1.5% polyethylene glycol functionalized methacryloxypropyl terminated polydimethylsiloxane, 1.50% PEGDMA, 0.62% 819, and 1.00% HMEPB. The total amount above was 100%, including monomers, an initiator, and a crosslinking agent. Taking the above total amount as the denominator in weight percentage, 10.00% ethyl acetate and 10.00% ethyl lactate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 100 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 16.89°.

### Embodiment 36

Step S100: providing a lens body. The lens body of this embodiment is the sixth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 14.40% TRIS, 16.32% MPDMS, 12.00% HEMA, 54.24% NVP, 0.58% polyethylene glycol functionalized methacryloxypropyl terminated polydimethylsiloxane, 1.26% TEGDMA, 0.60% 819, and 0.60% HMEPB. The total amount above was 100%, including monomers, an initiator, and a crosslinking agent. Taking the above total amount as the denominator in weight percentage, 10.00% hexanol and 10.00% propyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 100 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 25.37°.

### Embodiment 37

Step S100: providing a lens body. The lens body of this embodiment is the seventh of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 17.26% 3-[tris(trimethylsiloxy)silyl]propyl vinyl carbamate, 16.15% MPDMS, 16.00% HEMA, 49.95% NVP, 0.40% TEGDMA, and 0.24% 819. The total amount above was 100%, including monomers, an initiator, and a crosslinking agent. Taking the above total amount as the denominator in weight percentage, 12.10% hexanol and 12.10% tAA were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex III became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 100 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 13.79°.

### Embodiment 38

Step S100: providing a lens body. The lens body of this embodiment is the eighth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 17.25% SIGMA, 13.52% methacryloxymethylphenethyltris(trimethylsiloxy)silane, 20.00% HEMA, 47.18% NVP, 1.36% EGDMA, and 0.69% 819. The total amount above was 100%, including monomers, an initiator, and a crosslinking agent. Taking the above total amount as the denominator in weight percentage, 11.44% IPA and 11.44% hexanol were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 100 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 38.04°.

### Embodiment 39

Step S100: providing a lens body. The lens body of this embodiment is the ninth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 5.70% SIGMA, 11.11% 3-[tris(trimethylsiloxy)silyl]propyl vinyl carbamate, 12.00% MPDMS, 34.58% NVP, 33.40% DMA, 1.38% DEGVE, 1.15% TEGDMA, and 0.68% 819. The total amount above was 100%, including monomers, an initiator, and a crosslinking agent. Taking the above total amount as the denominator in weight percentage, 11.33% butyl acetate and 11.33% hexanol were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 100 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 80.47°.

### Embodiment 40

Step S100: providing a lens body. The lens body of this embodiment is the tenth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 13.15% TRIS, 10.25% (methacryloxymethyl)bis(trimethylsiloxy)-methylsilane, 10.25% HEMA, 32.06% NVP, 31.54% DMA, 1.21% BVE, 0.80% EGDMA, 0.10% TEGDVE, and 0.64% 819. The total amount above was 100%, including monomers, an initiator, and a crosslinking agent. Taking the above total amount as the denominator in weight percentage, 10.44% ethyl lactate and 12.44% hexanol were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 100 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 32.03°.

### Embodiment 41

Step S100: providing a lens body. The lens body of this embodiment is the first of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 12.70% SIGMA, 15.61% MPDMS (having a molecular weight of about 1000), 1.57% MMA, 65.67% NVP, 1.35% DMPDMS, 1.95% TEGDMA, 0.58% 819, and 0.57% HMEPB. The total amount above was 100%, including monomers, an initiator, and a crosslinking agent. Taking the above total amount as the denominator in weight percentage, 9.53% hexanol and 9.53% ethyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 200 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 51.47°.

### Embodiment 42

Step S100: providing a lens body. The lens body of this embodiment is the second of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 15.17% TRIS, 18.25% (methacryloxymethyl)bis(trimethylsiloxy)methylsilane, 3.37% IBM, 61.65% NVP, 0.34% TEGDMA, 0.61% 819, and 0.61% HMEPB. The total amount above was 100%, including monomers, an initiator, and a crosslinking agent. Taking the above total amount as the denominator in weight percentage, 10.17% hexanol and 9.53% ethyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 200 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 46.38°.

### Embodiment 43

Step S100: providing a lens body. The lens body of this embodiment is the third of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 16.11% SIGMA, 18.23% (methacryloxymethyl)bis(trimethylsiloxy)-methylsilane, 2.00% HEMA, 54.15% NVP, 5.33% IBM, 2.50% DMPDMS, 1.00% TEGDMA, and 0.68% 819. The total amount above was 100%, including monomers, an initiator, and a crosslinking agent. Taking the above total amount as the denominator in weight percentage, 11.33% hexanol and 11.33% propyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 200 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 13.98°.

### Embodiment 44

Step S100: providing a lens body. The lens body of this embodiment is the fourth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 24.59% methacryloxymethylphenethyltris(trimethylsiloxy)silane, 15.39% O-(methacryloxyethyl)-3-[bis(trimethylsiloxy)methylsilyl]-propylcarbamate, 4.00% HEMA, 53.55% NVP, 0.89% EGDMA, 0.60% 819, and 0.98% HMEPB. The total amount above was 100%, including monomers, an initiator, and a crosslinking agent. Taking the above total amount as the denominator in weight percentage, 10.00% ethyl acetate and 10.00% TPME were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 200 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 8.09°.

### Embodiment 45

Step S100: providing a lens body. The lens body of this embodiment is the fifth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 23.25% 3-[tris(trimethylsiloxy)silyl]propyl vinyl carbamate, 27.15% (methacryloxymethyl)bis(trimethylsiloxy)methylsilane, 8.00% HEMA, 1.00% EOEMA, 35.98% NVP, 1.5% polyethylene glycol functionalized methacryloxypropyl terminated polydimethylsiloxane, 1.50% PEGDMA, 0.62% 819, and 1.00% HMEPB. The total amount above was 100%, including monomers, an initiator, and a crosslinking agent. Taking the above total amount as the denominator in weight percentage, 10.00% ethyl acetate and 10.00% ethyl lactate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 200 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 7.46°.

### Embodiment 46

Step S100: providing a lens body. The lens body of this embodiment is the sixth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 14.40% TRIS, 16.32% MPDMS, 12.00% HEMA, 54.24% NVP, 0.58% polyethylene glycol functionalized methacryloxypropyl terminated polydimethylsiloxane, 1.26% TEGDMA, 0.60% 819, and 0.60% HMEPB. The total amount above was 100%, including monomers, an initiator, and a crosslinking agent. Taking the above total amount as the denominator in weight percentage, 10.00% hexanol and 10.00% propyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 1 wt % PAA having a molecular weight of 200 kDa and 99 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 13.55°.

### Embodiment 47

Step S100: providing a lens body. The lens body of this embodiment is the seventh of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 17.26% 3-[tris(trimethylsiloxy)silyl]propyl vinyl carbamate, 16.15% MPDMS, 16.00% HEMA, 49.95% NVP, 0.40% TEGDMA, and 0.24% 819. The total amount above was 100%, including monomers, an initiator, and a crosslinking agent. Taking the above total amount as the denominator in weight percentage, 12.10% hexanol and 12.10% tAA were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 200 kDa and 97 wt % an aqueous organic solution. The organic solvent accounted for, e.g., 30 wt % of the aqueous organic solution, wherein the organic solvent was, for example, dipropylene glycol n-butyl ether. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 16.01°.

### Embodiment 48

Step S100: providing a lens body. The lens body of this embodiment is the eighth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 17.25% SIGMA, 13.52% methacryloxymethylphenethyltris-(trimethylsiloxy)silane, 20.00% HEMA, 47.18% NVP, 1.36% EGDMA, and 0.69% 819. The total amount above was 100%, including monomers, an initiator, and a crosslinking agent. Taking the above total amount as the denominator in weight percentage, 11.44% IPA and 11.44% hexanol were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 200 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 42.96°.

### Embodiment 49

Step S100: providing a lens body. The lens body of this embodiment is the ninth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 5.70% SIGMA, 11.11% 3-[tris(trimethylsiloxy)silyl]propyl vinyl carbamate, 12.00% MPDMS, 34.58% NVP, 33.40% DMA, 1.38% DEGVE, 1.15% TEGDMA, and 0.68% 819. The total amount above was 100%, including monomers, an initiator, and a crosslinking agent. Taking the above total amount as the denominator in weight percentage, 11.33% butyl acetate and 11.33% hexanol were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 200 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 69.77°.

### Embodiment 50

Step S100: providing a lens body. The lens body of this embodiment is the tenth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 13.15% TRIS, 10.25% (methacryloxymethyl)bis(trimethylsiloxy)-methylsilane, 10.25% HEMA, 32.06% NVP, 31.54% DMA, 1.21% BVE, 0.80% EGDMA, 0.10% TEGDVE, and 0.64% 819. The total amount above was 100%, including monomers, an initiator, and a crosslinking agent. Taking the above total amount as the denominator in weight percentage, 10.44% ethyl lactate and 12.44% hexanol were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 200 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 41.48°.

### Embodiment 51

Step S100: providing a lens body. The lens body of this embodiment is the first of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 12.70% SIGMA, 15.61% MPDMS (having a molecular weight of about 1000), 1.57% MMA, 65.67% NVP, 1.35% DMPDMS, 1.95% TEGDMA, 0.58% 819, and 0.57% HMEPB. The total amount above was 100%, including monomers, an initiator, and a crosslinking agent. Taking the above total amount as the denominator in weight percentage, 9.53% hexanol and 9.53% ethyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 450 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 48.15°.

### Embodiment 52

Step S100: providing a lens body. The lens body of this embodiment is the second of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 15.17% TRIS, 18.25% (methacryloxymethyl)bis(trimethylsiloxy)methylsilane, 3.37% IBM, 61.65% NVP, 0.34% TEGDMA, 0.61% 819, and 0.61% HMEPB. The total amount above was 100%, including monomers, an initiator, and a crosslinking agent. Taking the above total amount as the denominator in weight percentage, 10.17% hexanol and 9.53% ethyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 450 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 47.09°.

### Embodiment 53

Step S100: providing a lens body. The lens body of this embodiment is the third of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 16.11% SIGMA, 18.23% (methacryloxymethyl)bis(trimethylsiloxy)-methylsilane, 2.00% HEMA, 54.15% NVP, 5.33% IBM, 2.50% DMPDMS, 1.00% TEGDMA, and 0.68% 819. The total amount above was 100%, including monomers, an initiator, and a crosslinking agent. Taking the above total amount as the denominator in weight percentage, 11.33% hexanol and 11.33% propyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 450 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 15.72°.

### Embodiment 54

Step S100: providing a lens body. The lens body of this embodiment is the fourth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 24.59% methacryloxymethylphenethyltris(trimethylsiloxy)silane, 15.39% O-(methacryloxyethyl)-3-[bis(trimethylsiloxy)methylsilyl]-propylcarbamate, 4.00% HEMA, 53.55% NVP, 0.89% EGDMA, 0.60% 819, and 0.98% HMEPB. The total amount above was 100%, including monomers, an initiator, and a crosslinking agent. Taking the above total amount as the denominator in weight percentage, 10.00% ethyl acetate and 10.00% TPME were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 450 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 7.98°.

### Embodiment 55

Step S100: providing a lens body. The lens body of this embodiment is the fifth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 23.25% 3-[tris(trimethylsiloxy)silyl]propyl vinyl carbamate, 27.15% (methacryloxymethyl)bis(trimethylsiloxy)methylsilane, 8.00% HEMA, 1.00% EOEMA, 35.98% NVP, 1.5% polyethylene glycol functionalized methacryloxypropyl terminated polydimethylsiloxane, 1.50% PEGDMA, 0.62% 819, and 1.00% HMEPB. The total amount above was 100%, including monomers, an initiator, and a crosslinking agent. Taking the above total amount as the denominator in weight percentage, 10.00% ethyl acetate and 10.00% ethyl lactate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 450 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 6.5°.

### Embodiment 56

Step S100: providing a lens body. The lens body of this embodiment is the sixth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 14.40% TRIS, 16.32% MPDMS, 12.00% HEMA, 54.24% NVP, 0.58% polyethylene glycol functionalized methacryloxypropyl terminated polydimethylsiloxane, 1.26% TEGDMA, 0.60% 819, and 0.60% HMEPB. The total amount above was 100%, including monomers, an initiator, and a crosslinking agent. Taking the above total amount as the denominator in weight percentage, 10.00% hexanol and 10.00% propyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 450 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 8.19°.

### Embodiment 57

Step S100: providing a lens body. The lens body of this embodiment is the seventh of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 17.26% 3-[tris(trimethylsiloxy)silyl]propyl vinyl carbamate, 16.15% MPDMS, 16.00% HEMA, 49.95% NVP, 0.40% TEGDMA, and 0.24% 819. The total amount above was 100%, including monomers, an initiator, and a crosslinking agent. Taking the above total amount as the denominator in weight percentage, 12.10% hexanol and 12.10% tAA were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 450 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 20.14°.

### Embodiment 58

Step S100: providing a lens body. The lens body of this embodiment is the eighth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 17.25% SIGMA, 13.52% methacryloxymethylphenethyltris-(trimethylsiloxy)silane, 20.00% HEMA, 47.18% NVP, 1.36% EGDMA, and 0.69% 819. The total amount above was 100%, including monomers, an initiator, and a crosslinking agent. Taking the above total amount as the denominator in weight percentage, 11.44% IPA and 11.44% hexanol were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 450 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 49.87°.

### Embodiment 59

Step S100: providing a lens body. The lens body of this embodiment is the ninth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 5.70% SIGMA, 11.11% 3-[tris(trimethylsiloxy)silyl]propyl vinyl carbamate, 12.00% MPDMS, 34.58% NVP, 33.40% DMA, 1.38% DEGVE, 1.15% TEGDMA, and 0.68% 819. The total amount above was 100%, including monomers, an initiator, and a crosslinking agent. Taking the above total amount as the denominator in weight percentage, 11.33% butyl acetate and 11.33% hexanol were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 450 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 72.06°.

### Embodiment 60

Step S100: providing a lens body. The lens body of this embodiment is the tenth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 13.15% TRIS, 10.25% (methacryloxymethyl)bis(trimethylsiloxy)-methylsilane, 10.25% HEMA, 32.06% NVP, 31.54% DMA, 1.21% BVE, 0.80% EGDMA, 0.10% TEGDVE, and 0.64% 819. The total amount above was 100%, including monomers, an initiator, and a crosslinking agent. Taking the above total amount as the denominator in weight percentage, 10.44% ethyl lactate and 12.44% hexanol were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 450 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 36.74°.

### Embodiment 61

Step S100: providing a lens body. The lens body of this embodiment is the first of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 12.70% SIGMA, 15.61% MPDMS (having a molecular weight of about 1000), 1.57% MMA, 65.67% NVP, 1.35% DMPDMS, 1.95% TEGDMA, 0.58% 819, and 0.57% HMEPB. The total amount above was 100%, including monomers, an initiator, and a crosslinking agent. Taking the above total amount as the denominator in weight percentage, 9.53% hexanol and 9.53% ethyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 1250 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 50.27°.

### Embodiment 62

Step S100: providing a lens body. The lens body of this embodiment is the second of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 15.17% TRIS, 18.25% (methacryloxymethyl)bis(trimethylsiloxy)methylsilane, 3.37% IBM, 61.65% NVP, 0.34% TEGDMA, 0.61% 819, and 0.61% HMEPB. The total amount above was 100%, including monomers, an initiator, and a crosslinking agent. Taking the above total amount as the denominator in weight percentage, 10.17% hexanol and 9.53% ethyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 1250 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 52.07°.

### Embodiment 63

Step S100: providing a lens body. The lens body of this embodiment is the third of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 16.11% SIGMA, 18.23% (methacryloxymethyl)bis(trimethylsiloxy)-methylsilane, 2.00% HEMA, 54.15% NVP, 5.33% IBM, 2.50% DMPDMS, 1.00% TEGDMA, and 0.68% 819. The total amount above was 100%, including monomers, an initiator, and a crosslinking agent. Taking the above total amount as the denominator in weight percentage, 11.33% hexanol and 11.33% propyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 1250 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 18.64°.

### Embodiment 64

Step S100: providing a lens body. The lens body of this embodiment is the fourth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 24.59% methacryloxymethylphenethyltris(trimethylsiloxy)silane, 15.39% O-(methacryloxyethyl)-3-[bis(trimethylsiloxy)methylsilyl]-propylcarbamate, 4.00% HEMA, 53.55% NVP, 0.89% EGDMA, 0.60% 819, and 0.98% HMEPB. The total amount above was 100%, including monomers, an initiator, and a crosslinking agent. Taking the above total amount as the denominator in weight percentage, 10.00% ethyl acetate and 10.00% TPME were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 1250 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 13.28°.

### Embodiment 65

Step S100: providing a lens body. The lens body of this embodiment is the fifth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 23.25% 3-[tris(trimethylsiloxy)silyl]propyl vinyl carbamate, 27.15% (methacryloxymethyl)bis(trimethylsiloxy)methylsilane, 8.00% HEMA, 1.00% EOEMA, 35.98% NVP, 1.5% polyethylene glycol functionalized methacryloxypropyl terminated polydimethylsiloxane, 1.50% PEGDMA, 0.62% 819, and 1.00% HMEPB. The total amount above was 100%, including monomers, an initiator, and a crosslinking agent. Taking the above total amount as the denominator in weight percentage, 10.00% ethyl acetate and 10.00% ethyl lactate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 1250 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 10.94°.

### Embodiment 66

Step S100: providing a lens body. The lens body of this embodiment is the sixth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 14.40% TRIS, 16.32% MPDMS, 12.00% HEMA, 54.24% NVP, 0.58% polyethylene glycol functionalized methacryloxypropyl terminated polydimethylsiloxane, 1.26% TEGDMA, 0.60% 819, and 0.60% HMEPB. The total amount above was 100%, including monomers, an initiator, and a crosslinking agent. Taking the above total amount as the denominator in weight percentage, 10.00% hexanol and 10.00% propyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 1250 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 9.06°.

### Embodiment 67

Step S100: providing a lens body. The lens body of this embodiment is the seventh of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 17.26% 3-[tris(trimethylsiloxy)silyl]propyl vinyl carbamate, 16.15% MPDMS, 16.00% HEMA, 49.95% NVP, 0.40% TEGDMA, and 0.24% 819. The total amount above was 100%, including monomers, an initiator, and a crosslinking agent. Taking the above total amount as the denominator in weight percentage, 12.10% hexanol and 12.10% tAA were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 1250 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 22.71°.

### Embodiment 68

Step S100: providing a lens body. The lens body of this embodiment is the eighth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 17.25% SIGMA, 13.52% methacryloxymethylphenethyltris-(trimethylsiloxy)silane, 20.00% HEMA, 47.18% NVP, 1.36% EGDMA, and 0.69% 819. The total amount above was 100%, including monomers, an initiator, and a crosslinking agent. Taking the above total amount as the denominator in weight percentage, 11.44% IPA and 11.44% hexanol were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 1250 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 30.93°.

### Embodiment 69

Step S100: providing a lens body. The lens body of this embodiment is the ninth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 5.70% SIGMA, 11.11% 3-[tris(trimethylsiloxy)silyl]propyl vinyl carbamate, 12.00% MPDMS, 34.58% NVP, 33.40% DMA, 1.38% DEGVE, 1.15% TEGDMA, and 0.68% 819. The total amount above was 100%, including monomers, an initiator, and a crosslinking agent. Taking the above total amount as the denominator in weight percentage, 11.33% butyl acetate and 11.33% hexanol were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 1250 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 69.46°.

### Embodiment 70

Step S100: providing a lens body. The lens body of this embodiment is the tenth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 13.15% TRIS, 10.25% (methacryloxymethyl)bis(trimethylsiloxy)-methylsilane, 10.25% HEMA, 32.06% NVP, 31.54% DMA, 1.21% BVE, 0.80% EGDMA, 0.10% TEGDVE, and 0.64% 819. The total amount above was 100%, including monomers, an initiator, and a crosslinking agent. Taking the above total amount as the denominator in weight percentage, 10.44% ethyl lactate and 12.44% hexanol were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 1250 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 38.09°.

### Embodiment 71

Step S100: providing a lens body. The lens body of this embodiment is the first of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 12.70% SIGMA, 15.61% MPDMS (having a molecular weight of about 1000), 1.57% MMA, 65.67% NVP, 1.35% DMPDMS, 1.95% TEGDMA, 0.58% 819, and 0.57% HMEPB. The total amount above was 100%, including monomers, an initiator, and a crosslinking agent. Taking the above total amount as the denominator in weight percentage, 9.53% hexanol and 9.53% ethyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3000 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 51.29°.

### Embodiment 72

Step S100: providing a lens body. The lens body of this embodiment is the second of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 15.17% TRIS, 18.25% (methacryloxymethyl)bis(trimethylsiloxy)methylsilane, 3.37% IBM, 61.65% NVP, 0.34% TEGDMA, 0.61% 819, and 0.61% HMEPB. The total amount above was 100%, including monomers, an initiator, and a crosslinking agent. Taking the above total amount as the denominator in weight percentage, 10.17% hexanol and 9.53% ethyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3000 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 63.69°.

### Embodiment 73

Step S100: providing a lens body. The lens body of this embodiment is the third of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 16.11% SIGMA, 18.23% (methacryloxymethyl)bis(trimethylsiloxy)-methylsilane, 2.00% HEMA, 54.15% NVP, 5.33% IBM, 2.50% DMPDMS, 1.00% TEGDMA, and 0.68% 819. The total amount above was 100%, including monomers, an initiator, and a crosslinking agent. Taking the above total amount as the denominator in weight percentage, 11.33% hexanol and 11.33% propyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3000 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 16.74°.

### Embodiment 74

Step S100: providing a lens body. The lens body of this embodiment is the fourth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 24.59% methacryloxymethylphenethyltris(trimethylsiloxy)silane, 15.39% O-(methacryloxyethyl)-3-[bis(trimethylsiloxy)methylsilyl]-propylcarbamate, 4.00% HEMA, 53.55% NVP, 0.89% EGDMA, 0.60% 819, and 0.98% HMEPB. The total amount above was 100%, including monomers, an initiator, and a crosslinking agent. Taking the above total amount as the denominator in weight percentage, 10.00% ethyl acetate and 10.00% TPME were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3000 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 11.43°.

### Embodiment 75

Step S100: providing a lens body. The lens body of this embodiment is the fifth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 23.25% 3-[tris(trimethylsiloxy)silyl]propyl vinyl carbamate, 27.15% (methacryloxymethyl)bis(trimethylsiloxy)methylsilane, 8.00% HEMA, 1.00% EOEMA, 35.98% NVP, 1.5% polyethylene glycol functionalized methacryloxypropyl terminated polydimethylsiloxane, 1.50% PEGDMA, 0.62% 819, and 1.00% HMEPB. The total amount above was 100%, including monomers, an initiator, and a crosslinking agent. Taking the above total amount as the denominator in weight percentage, 10.00% ethyl acetate and 10.00% ethyl lactate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3000 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 14.08°.

### Embodiment 76

Step S100: providing a lens body. The lens body of this embodiment is the sixth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 14.40% TRIS, 16.32% MPDMS, 12.00% HEMA, 54.24% NVP, 0.58% polyethylene glycol functionalized methacryloxypropyl terminated polydimethylsiloxane, 1.26% TEGDMA, 0.60% 819, and 0.60% HMEPB. The total amount above was 100%, including monomers, an initiator, and a crosslinking agent. Taking the above total amount as the denominator in weight percentage, 10.00% hexanol and 10.00% propyl acetate were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3000 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 12.15°.

### Embodiment 77

Step S100: providing a lens body. The lens body of this embodiment is the seventh of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 17.26% 3-[tris(trimethylsiloxy)silyl]propyl vinyl carbamate, 16.15% MPDMS, 16.00% HEMA, 49.95% NVP, 0.40% TEGDMA, and 0.24% 819. The total amount above was 100%, including monomers, an initiator, and a crosslinking agent. Taking the above total amount as the denominator in weight percentage, 12.10% hexanol and 12.10% tAA were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3000 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 23.07°.

### Embodiment 78

Step S100: providing a lens body. The lens body of this embodiment is the eighth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 17.25% SIGMA, 13.52% methacryloxymethylphenethyltris-(trimethylsiloxy)silane, 20.00% HEMA, 47.18% NVP, 1.36% EGDMA, and 0.69% 819. The total amount above was 100%, including monomers, an initiator, and a crosslinking agent. Taking the above total amount as the denominator in weight percentage, 11.44% IPA and 11.44% hexanol were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3000 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 41.98°.

### Embodiment 79

Step S100: providing a lens body. The lens body of this embodiment is the ninth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 5.70% SIGMA, 11.11% 3-[tris(trimethylsiloxy)silyl]propyl vinyl carbamate, 12.00% MPDMS, 34.58% NVP, 33.40% DMA, 1.38% DEGVE, 1.15% TEGDMA, and 0.68% 819. The total amount above was 100%, including monomers, an initiator, and a crosslinking agent. Taking the above total amount as the denominator in weight percentage, 11.33% butyl acetate and 11.33% hexanol were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3000 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 76.98°.

### Embodiment 80

Step S100: providing a lens body. The lens body of this embodiment is the tenth of ten different formulations for the preparation of a composition in the embodiments. Different formulations are distinct in the content of silicone units, the content of non-silicone units, the types of silicone units and the types of non-silicone units. In this embodiment, the lens formulation was formulated according to the following proportions: 13.15% TRIS, 10.25% (methacryloxymethyl)bis(trimethylsiloxy)-methylsilane, 10.25% HEMA, 32.06% NVP, 31.54% DMA, 1.21% BVE, 0.80% EGDMA, 0.10% TEGDVE, and 0.64% 819. The total amount above was 100%, including monomers, an initiator, and a crosslinking agent. Taking the above total amount as the denominator in weight percentage, 10.44% ethyl lactate and 12.44% hexanol were additionally added to the lens formulation. The mixed formulation was stirred under nitrogen for more than 4 h to ensure that the mixed formulation was completely uniformly mixed. The mixed formulation was injected into a female mold made by injection molding, and then a male mold made by injection molding was pressed together with the female mold, thereby forming a formulation-mold complex. The mixed liquid formulation was present in a space between the male mold and the female mold. The formulation-mold complex was cured by light. The ambient temperature was kept between 33° C. and 38° C., and the irradiation time was 60 min. After the curing process, the formulation-mold complex became a lens formulation complex. At this time, the lens in the lens formulation complex was a dry lens (which had not been hydrated).

Step S200: formulating a hydration solution. The hydration solution (hydration solution 1) in this embodiment was a complete mixture of 3 wt % PAA having a molecular weight of 3000 kDa and 97 wt % an aqueous organic solution. The organic solvent accounted for, e.g., 30 wt % of the aqueous organic solution, wherein the organic solvent was, for example, IPA. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, and the lens body was immersed sequentially in the four tanks each for 1 h, a total of 4 h. Stirring may also be performed during immersion. In this step, the immersion time may be extended or shortened, and the number of tank changes may be increased or reduced. The more times the tanks are changed, the total immersion time should be further shortened. For example, the immersion may be performed sequentially in five tanks, each for half an hour. The immersion temperature was room temperature. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 40.17°.

### Embodiment 81

Step S100: providing a lens body according to step S100 in Embodiment 80, that is, a dry lens (a lens that has not been hydrated).

Step S200: formulating a hydration solution. The hydration solution (hydration solution 1) in this embodiment was a complete mixture of 1 wt % PAA having a molecular weight of 200 kDa and 99 wt % an aqueous organic solution. The organic solvent accounted for, e.g., 30 wt % of the aqueous organic solution, wherein the organic solvent was, for example, IPA. Then sodium carbonate was added to adjust the pH value of the mixture to about 6.5. After adjustment, part of polyacrylic acid in the mixture was converted into sodium polyacrylate. In this embodiment, a first and second tanks of hydration solution were prepared for use.

Step S300: immersing the lens body in the hydration solution for at least 30 min. In this embodiment, the lens body was allowed to stand and immerse in the first tank of hydration solution for 1 h, and then in the second tank of hydration solution for 1 h, that is, the first part of the treatment was 2 h in total. The lens body can also be immersed in the same tank for sufficient time without moving to other tanks. The immersion temperature was room temperature.

Step S400: immersing the lens body in water or an aqueous solution for at least 60 min to form a contact lens. In this embodiment, four tanks were provided, each of which was filled with an aqueous buffer salt solution containing 0.05% Poloxamer 407. The lens body was immersed sequentially in the four tanks each for 30 minutes, a total of 2 h. Stirring may also be performed during immersion. In another embodiment, the lens body was immersed in water or an aqueous solution for at least 60 min to form a contact lens. The lens body may be immersed sequentially in four tanks, each tank for 15 min, a total of 60 min.

It was observed or measured and calculated that the five experimental contact lenses prepared in this embodiment had an average contact angle of 48.87°.

Control groups 1-2 are shown as follows.

### Control Group 1:

The lens body used in control group 1 was the same as those in Embodiments 3, 13, 23, 33, 43, 53, 63, and 73, except that it was hydrated using an aqueous solution of 50 wt % isopropyl alcohol as a hydration solution, and then immersed in water. The lens body was firstly immersed in the hydration solution of an aqueous solution of 50 wt % isopropyl alcohol for 1 h, and then immersed in a tank with water at a constant temperature of 60° C. for 1 h. There were six tanks in total. The lens body was immersed in the six tanks each for 1 h. It was observed or measured and calculated that the lens had an average contact angle of 99.06°.

### Control Group 2:

The lens body used in control group 2 was the same as those in Embodiments 4, 14, 24, 34, 44, 54, 64, and 74, except that it was directly hydrated with water. Firstly, the lens body was immersed in tanks at room temperature, wherein there were four tanks. The lens body was immersed in the four tanks each for 1 h, a total of 4 h. It was allowed to stand and immerse for sufficient time. It was observed or measured and calculated that the lens had an average contact angle of 117.23°.

In summary, the contact lens and the silicone hydrogel contact lens according to the embodiments of the present invention include at least one silicone monomer, and the surfaces of the contact lens and the silicone hydrogel contact lens have polyacrylic acid and/or sodium polyacrylate, wherein polyacrylic acid and/or sodium polyacrylate has a molecular weight of greater than 100 kDa. Hence, the contact lens and the silicone hydrogel contact lens produced have the advantages of good hydrophilicity and being suitable for consumers' long-time wearing. In addition, the method of making a contact lens according to the embodiments of the present invention can save energy consumption, lower the complexity of the manufacturing process, and reduce safety risk, because it does not require heating for temperature control and does not require to control the pH value of the hydrated liquid in the manufacturing process as a necessary condition. Therefore, the method can reduce manufacturing costs and contribute to the production of contact lenses.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A contact lens comprising at least one silicone monomer, wherein a surface of the contact lens comprises polyacrylic acid and/or sodium polyacrylate, and a molecular weight of the polyacrylic acid and/or the sodium polyacrylate is greater than 100 kDa.

2. The contact lens according to claim 1, wherein a molecular weight of the polyacrylic acid and/or the sodium polyacrylate is greater than 200 kDa.

3. The contact lens according to claim 1, wherein a molecular weight of the polyacrylic acid and/or the sodium polyacrylate is greater than 450 kDa.

4. The contact lens according to claim 1, wherein the at least one silicone monomer comprises at least one of 3-[tris(trimethylsiloxy)silyl]propyl methacrylate, 3-(3-methacryloxy-2-hydroxypropoxy)propylbis-(trimethylsiloxy)methylsilane, O-(methacryloxyethyl)-3-[bis(trimethylsiloxy)methylsilyl]propylcarbamate, and 3-[tris(trimethylsiloxy)silyl]propyl vinyl carbamate.

5. The contact lens according to claim 4, wherein the at least one silicone monomer further comprises at least one of monomethacryloxypropyl terminated polydimethylsiloxane, monomethacryloxypropyl terminated carbamate polydimethylsiloxane, and mono-(3-methacryloxy-2-hydroxypropyloxy)propyl terminated mono-butyl terminated polydimethylsiloxane.

6. The contact lens according to claim 1, wherein the contact lens comprises N-vinyl pyrrolidone or N-methyl-N-vinylacetamide.

7. The contact lens according to claim 6, wherein the contact lens further comprises a diluent, and the content of the N-vinyl pyrrolidone or the N-methyl-N-vinylacetamide accounts for 30%-65% by weight of the contact lens from which the diluent is deducted.

8. The contact lens according to claim 6, wherein the contact lens further comprises a diluent, and the content of the N-vinyl pyrrolidone or the N-methyl-N-vinylacetamide accounts for 35%-55% by weight of the contact lens from which the diluent is deducted.

9. The contact lens according to claim 6, wherein the contact lens comprises hydroxyethyl methacrylate.

10. The contact lens according to claim 5, further comprising at least one silicone crosslinking agent.

11. The contact lens according to claim 10, wherein the at least one silicone crosslinking agent further comprises at least one of methacryloxypropyl terminated polydimethylsiloxane, methacryloxypropyl terminated carbamate polydimethylsiloxane, polyethylene glycol functionalized methacryloxypropyl terminated polydimethylsiloxane, 1,3-bis[4-(vinyloxycarbonyloxy)butyl]tetramethyldisiloxane, and bis-3-methacryloxy-2-hydroxypropyloxypropyl polydimethylsiloxane.

12. The contact lens according to claim 10, wherein a molecular weight of the at least one silicone crosslinking agent is between 500 Da and 3000 Da.

13. The contact lens according to claim 1, wherein the contact lens further comprises at least one non-silicone crosslinking agent.

14. The contact lens according to claim 13, wherein the at least one non-silicone crosslinking agent comprises at least one of ethylene glycol dimethacrylate, triethylene glycol dimethacrylate, tetraethylene glycol dimethacrylate, and trimethylolpropane trimethacrylate.

15. The contact lens according to claim 1, wherein a contact angle of the contact lens is less than or equal to 60°, and a water break-up time (WBUT) of the contact lens is greater than or equal to 20 seconds.

16. A silicone hydrogel contact lens comprising a first silicone monomer, a second silicone monomer, a first hydrophilic monomer, a second hydrophilic monomer and a silicone crosslinking agent, wherein:
the first silicone monomer comprises the following structure: 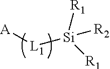
wherein A is the following structure: 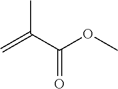
or the following structure: 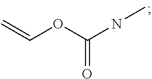
wherein R₁ is H or CH₃ or OSi(CH₃)₃; R₂ is H or CH₃ or OSi(CH₃)₃; and L₁ is the following structure or a combination thereof:
(CH₂)ₙ₁, (Cₘ₁H₂ₘ₁Oₘ₂)ₘ₃ or 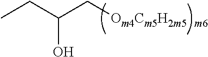
wherein n1 is 1-5, m1 is 1-4, m2 is 0-1, m3 is 1-4, m4 is 0-1, m5 is 1-4, and m6 is 1-4;
the second silicone monomer comprises a first structure or a second structure;
the first structure is: 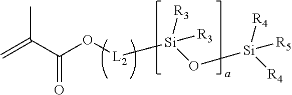
wherein a is 0-20; R₃ is H or CH₃ or C₂H₅; R₄ is H or CH₃ or OSi(CH₃)₃; R₅ is H or CH₃ or OSi(CH₃)₃; and L₂ is the following structure or a combination thereof:
(CH₂)ₙ₆, (Cₘ₇H₂ₘ₇Oₘ₈)ₘ₉, 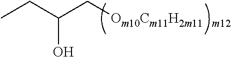
or
(CH₂)ₙ₇NHCO(Oₘ₁₃Cₘ₁₄H₂ₘ₁₄)ₘ₁₅
wherein n6 is 1-5, n7 is 1-5, m7 is 1-4, m8 is 0-1, m9 is 1-4, m10 is 0-1, m11 is 1-4, m12 is 1-4, m13 is 0-1, m14 is 1-4, and m15 is 1-4;
the second structure is: 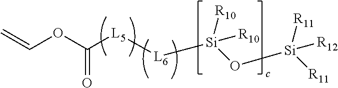
wherein c is 0-20; R₁₀ is H or CH₃ or C₂H₅; R₁₁ is H or CH₃ or OSi(CH₃)₃; R₁₂ is H or CH₃ or OSi(CH₃)₃; and L₅ is the following structure or a combination thereof: O or NH;
L₆ is the following structure or a combination thereof:
(CH₂)ₙ₂₀, (Cₘ₃₄H₂ₘ₃₄Oₘ₃₅)ₘ₃₆ or 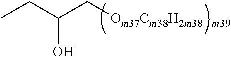
wherein n20 is 1-5, m34 is 1-4, m35 is 0-1, m36 is 1-4, m37 is 0-1, m38 is 1-4, and m39 is 1-4;
the first hydrophilic monomer is an N-vinyl-containing hydrophilic monomer;
the second hydrophilic monomer is different from the first hydrophilic monomer;
a surface of the silicone hydrogel contact lens comprises polyacrylic acid and/or sodium polyacrylate, and a molecular weight of the polyacrylic acid and/or the sodium polyacrylate is greater than 100 kDa.

17. The silicone hydrogel contact lens according to claim 16, wherein the first silicone monomer comprises at least one of 3-[tris(trimethylsiloxy)silyl]propyl methacrylate, 3-(3-methacryloxy-2-hydroxypropoxy)propylbis(trimethylsiloxy)methylsilane, O-(methacryloxyethyl)-3-[bis(trimethylsiloxy)methylsilyl]propylcarbamate, and 3-[tris(trimethylsiloxy)silyl]propyl vinyl carbamate.

18. The silicone hydrogel contact lens according to claim 16, wherein the second silicone monomer further comprises at least one of monomethacryloxypropyl terminated polydimethylsiloxane, monomethacryloxypropyl terminated carbamate polydimethylsiloxane, and mono-(3-methacryloxy-2-hydroxypropyloxy)propyl terminated mono-butyl terminated polydimethylsiloxane.

19. The silicone hydrogel contact lens according to claim 18, wherein a molecular weight of the second silicone monomer is 350-2500 Da.

20. The silicone hydrogel contact lens according to claim 18, wherein a molecular weight of the second silicone monomer is 500-1500 Da.

21. The silicone hydrogel contact lens according to claim 16, wherein the silicone hydrogel contact lens further comprises a diluent, and the total content of the first silicone monomer and the second silicone monomer accounts for 15%-60% by weight of the silicone hydrogel contact lens from which the diluent is deducted.

22. The silicone hydrogel contact lens according to claim 16, wherein the silicone hydrogel contact lens further comprises a diluent, and the total content of the first silicone monomer and the second silicone monomer accounts for 25%-45% by weight of the silicone hydrogel contact lens from which the diluent is deducted.

23. The silicone hydrogel contact lens according to claim 16, wherein the first hydrophilic monomer is N-vinyl pyrrolidone or N-methyl-N-vinylacetamide.

24. The silicone hydrogel contact lens according to claim 23, wherein the silicone hydrogel contact lens further comprises a diluent, and the content of the first hydrophilic monomer accounts for 30%-65% by weight of the silicone hydrogel contact lens from which the diluent is deducted.

25. The silicone hydrogel contact lens according to claim 23, wherein the silicone hydrogel contact lens further comprises a diluent, and the content of the first hydrophilic monomer accounts for 35%-55% by weight of the silicone hydrogel contact lens from which the diluent is deducted.

26. The silicone hydrogel contact lens according to claim 16, wherein the second hydrophilic monomer comprises hydroxyethyl methacrylate.

27. The silicone hydrogel contact lens according to claim 16, wherein the silicone crosslinking agent comprises the following structure: 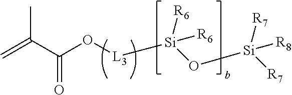
wherein b is 0-20; R₆ is H or CH₃ or C₂H₅; R₇ is H or CH₃ or OSi(CH₃)₃; and L₃ is the following structure or a combination thereof:
(CH₂)ₙ₁₂, (Cₘ₁₆H₂ₘ₁₆Oₘ₁₇)ₘ₁₈, 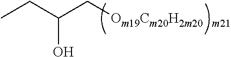
or (CH₂)ₙ₁₃NHCO(Oₘ₂₂Cₘ₂₃H₂ₘ₂₃)ₘ₂₄
wherein n12 is 1-5, n13 is 1-5, m16 is 1-4, m17 is 0-1, m18 is 1-4, m19 is 0-1, m20 is 1-4, m21 is 1-4, m22 is 0-1, m23 is 1-4, and m24 is 1-4;
R₈ is the following structure: 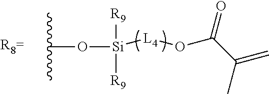
wherein R₉ is H or CH₃ or C₂H₅; and L₄ is the following structure or a combination thereof:
(CH₂)ₙ₁₈, (Cₘ₂₅H₂ₘ₂₅Oₘ₂₆)ₘ₂₇, 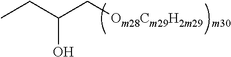
or (CH₂)ₙ₁₉NHCO(Oₘ₃₁Cₘ₃₂H₂ₘ₃₂)ₘ₃₃
wherein n18 is 1-5, n19 is 1-5, m25 is 1-4, m26 is 0-1, m27 is 1-4, m28 is 0-1, m29 is 1-4, m30 is 1-4, m31 is 0-1, m32 is 1-4, and m33 is 1-4.

28. The silicone hydrogel contact lens according to claim 16, wherein the silicone crosslinking agent comprises the following structure: 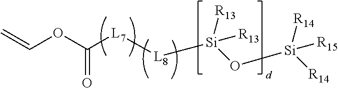
wherein d is 0-20; R₁₃ is H or CH₃ or C₂H₅; R₁₄ is H or CH₃ or C₂H₅; and L₇ is the following structure or a combination thereof: O or NH;
L₈ is the following structure or a combination thereof:
(CH₂)ₙ₂₅, (Cₘ₄₀H₂ₘ₄₀Oₘ₄₁)ₘ₄₂ or 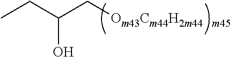
wherein n25 is 1-5, m40 is 1-4, m41 is 0-1, m42 is 1-4, m43 is 0-1, m44 is 1-4, and m45 is 1-4;
R₁₅ is the following structure: 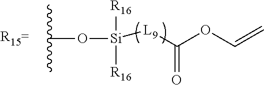
wherein R₁₆ is H or CH₃ or C₂H₅; and L₉ is the following structure or a combination thereof:
(CH₂)ₙ₃₁, (Cₘ₄₆H₂ₘ₄₆Oₘ₄₇)ₘ₄₈ or 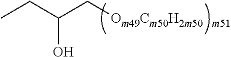
wherein n31 is 1-5, m46 is 1-4, m47 is 0-1, m48 is 1-4, m49 is 0-1, m50 is 1-4, and m51 is 1-4.

29. The silicone hydrogel contact lens according to claim 16, wherein the silicone crosslinking agent comprises at least one of methacryloxypropyl terminated polydimethylsiloxane, methacryloxypropyl terminated carbamate polydimethylsiloxane, polyethylene glycol functionalized methacryloxypropyl terminated polydimethylsiloxane, 1,3-bis[4-(vinyloxycarbonyloxy)butyl]tetramethyldisiloxane, and bis-3-methacryloxy-2-hydroxypropyloxypropyl polydimethylsiloxane.

30. The silicone hydrogel contact lens according to claim 29, wherein a molecular weight of the silicone crosslinking agent is between 500 Da and 3000 Da.

31. The silicone hydrogel contact lens according to claim 16, wherein the silicone hydrogel contact lens further comprises at least one non-silicone crosslinking agent.

32. The silicone hydrogel contact lens according to claim 31, wherein the at least one non-silicone crosslinking agent comprises at least one of ethylene glycol dimethacrylate, triethylene glycol dimethacrylate, tetraethylene glycol dimethacrylate, and trimethylolpropane trimethacrylate.

33. The silicone hydrogel contact lens according to claim 16, wherein a molecular weight of the polyacrylic acid and/or the sodium polyacrylate is greater than 200 kDa.

34. The silicone hydrogel contact lens according to claim 16, wherein a molecular weight of the polyacrylic acid and/or the sodium polyacrylate is greater than 450 kDa.
